(19) United States
(12) Patent Application Publication
(10) Pub. No.: US 2026/0289890 A1
(43) Pub. Date: Sep. 24, 2026

(54) SYSTEM

(71) Applicant: SoftBank Group Corp., Tokyo (JP)

(72) Inventor: Noriyuki KASAI, Tokyo (JP)

(73) Assignee: SoftBank Group Corp., Tokyo (JP)

(21) Appl. No.: 19/567,527

(22) Filed: Mar. 16, 2026

(30) Foreign Application Priority Data
Mar. 19, 2025 (JP) 2025-045088

(51) Int. Cl. G06T 13/80; G06F 16/432; G06F 16/435; G06F 16/438; G06F 40/295; G06F 40/40; G06T 11/60; G06V 40/16

(52) U.S. Cl. CPC G06T 13/80; G06F 16/434; G06F 16/436; G06F 16/438; G06F 40/295; G06F 40/40; G06T 11/60; G06V 40/174

(57) ABSTRACT

A system including a processor, wherein the processor is configured to receive, as input, an episode and an image relating to a past memory provided by a user, and analyze the episode and the image using natural language processing techniques to recognize an emotion of the user, generate, based on the recognized emotion, a prompt for instructing a generative artificial intelligence model to generate a story, and automatically create a visually appealing animation based on the generated story by using an image generation technique.

### CROSS-REFERENCE TO RELATED APPLICATION

This application is based on and claims priority under 35 USC 119 from Japanese Patent Application No. 2025-045088 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for preserving and presenting personal memories are largely limited to static media such as text, photographs, and simple slideshows, and therefore cannot sufficiently capture or express the emotional aspects of a user's experiences. Even when users attempt to manually create videos or animations from their own memories, such work requires specialized skills in editing, animation production, and storytelling, and thus imposes a high time and technical burden on ordinary users. Furthermore, existing automatic slideshow or video generation tools mainly rely on simple template-based processing and do not adequately utilize the user's emotional state to generate a customized narrative. As a result, there is a need for a system that can automatically generate emotionally rich, visually appealing animations from a user's past episodes and images, without requiring specialized knowledge, while effectively recognizing and reflecting the user's emotions in the generated content.

### SUMMARY

In order to solve the above-described problems, according to one aspect of the invention, there is provided a system comprising a processor, wherein the processor is configured to receive, as input, an episode and an image relating to a past memory provided by a user, and analyze the episode and the image using natural language processing techniques to recognize an emotion of the user. The processor is further configured to generate, based on the recognized emotion, a prompt for instructing a generative artificial intelligence model to generate a story, and to automatically create a visually appealing animation based on the generated story by using an image generation technique. In one embodiment, the processor is configured to generate, based on the story created by the generative artificial intelligence model, images for respective frames and create the animation by successively displaying the images. In another embodiment, the processor is configured to operate on a mobile information terminal and to receive input data and provide the animation via a user interface, thereby enabling the user to easily input episodes and images and to view the generated animation on a portable device. By these means, the system can automatically generate emotionally resonant, personalized animations from user-provided memories, while reducing the burden on the user and enhancing the expressive quality of the preserved memories.

The term “processor” refers to one or more hardware processing units, such as a central processing unit (CPU), graphics processing unit (GPU), digital signal processor (DSP), or other computation circuitry, and may further include associated memory and control logic configured to execute programs or processing routines.

The term “episode” refers to a piece of information expressing a user's past experience or memory, typically represented as natural language text describing events, situations, or scenes.

The term “image” refers to a still visual representation, such as a photograph, picture, or digitally created graphic, which may be stored in any suitable digital format and which depicts at least part of a user's past memory.

The term “past memory” refers to an experience or event that has occurred in the past for the user and that can be described or represented by an episode and/or an image.

The term “natural language processing techniques” refers to computational methods and algorithms that analyze and interpret human language expressed in text, including but not limited to tokenization, parsing, sentiment analysis, semantic analysis, and entity recognition.

The term “emotion of the user” refers to an affective state or sentiment of the user, such as happiness, sadness, nostalgia, excitement, or other emotional categories, inferred from the episode and/or the image.

The term “prompt” refers to a text or structured input data generated for the purpose of instructing a generative artificial intelligence model to perform a specific task, such as generating a story based on the user's emotion and memory.

The term “generative artificial intelligence model” refers to a machine learning model that is configured to generate new content, such as text or stories, in response to an input prompt, including but not limited to transformer-based language models and other generative models.

The term “story” refers to a sequence of sentences or narrative elements generated by the generative artificial intelligence model, which describes events, characters, and scenes corresponding to or derived from the user's episode, image, and recognized emotion.

The term “image generation technique” refers to a computational method or algorithm that generates one or more images from input data, such as a story, prompt, or other features, including but not limited to generative adversarial networks, diffusion models, and neural rendering methods.

The term “animation” refers to a moving visual representation created by displaying a sequence of images or frames over time, thereby giving the perception of motion and depicting at least part of the story associated with the user's past memory.

The term “frame” refers to a single still image within a sequence of images that collectively form an animation when displayed successively in chronological order.

The term “mobile information terminal” refers to a portable electronic device, such as a smartphone, tablet, or similar mobile computing device, that includes a processor, a display, and communication capabilities, and is capable of executing the system's functions.

The term “user interface” refers to a software and/or hardware interface through which the user interacts with the system, including input components such as touchscreens, keyboards, and microphones, and output components such as displays and speakers, for entering episodes and images and for viewing or playing back animations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

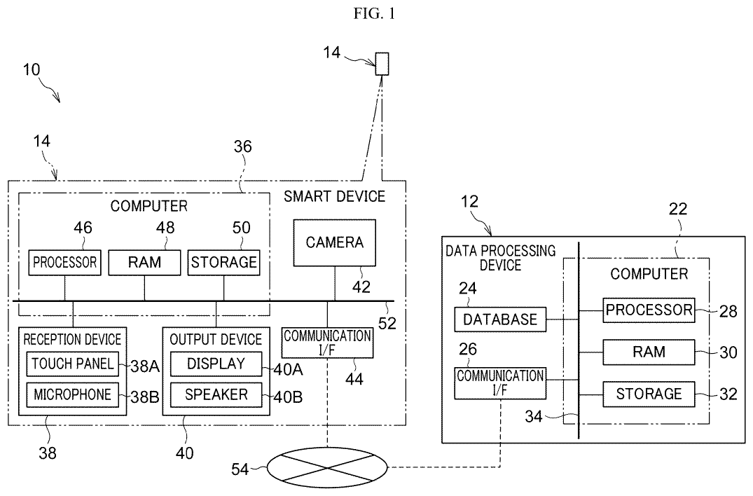

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

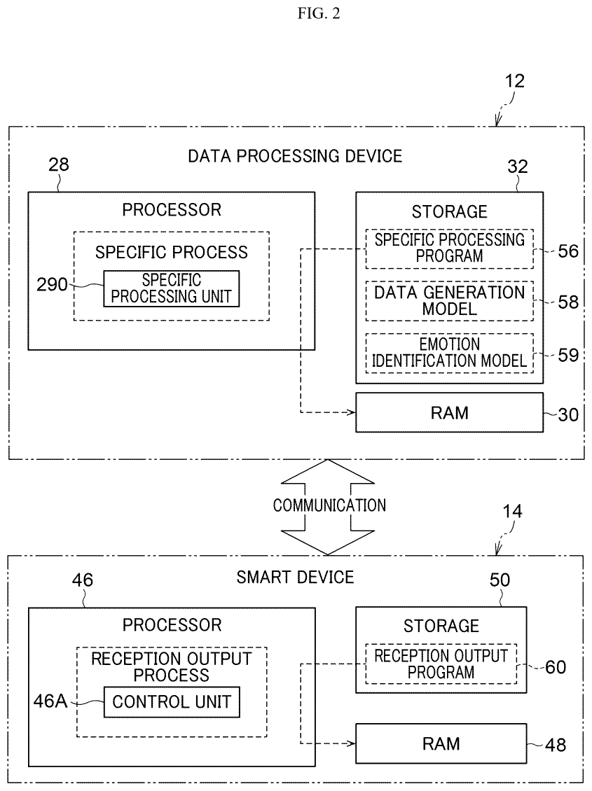

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content generation systems that utilize generative AI models typically receive raw user text or images and directly pass such raw data to the generative AI model. These systems often lack a structured integration of heterogeneous inputs, such as natural language event descriptions and associated imaging information, and therefore treat the generative AI model as a “black box” that is driven by unrefined prompts. As a result, the generated content may fail to accurately reflect the user's actual experience, emotional state, or visual context, and may require extensive trial-and-error prompting by the user. This leads to inefficient use of computational resources, increased network traffic to external AI services, and degraded user satisfaction.

Furthermore, existing systems do not sufficiently exploit specialized analysis components, such as natural language processing functions and image analysis functions, to pre-process user inputs and to construct optimized prompt sentences for the generative AI model. In many implementations, the lack of an intermediate integrated event representation causes redundant or inconsistent calls to AI services, and prevents the system from systematically controlling the behavior of the generative AI model across iterative refinements. This results in poor controllability, difficulty in reproducing outputs, and a lack of traceability of how user data is transformed into generated content.

Additionally, when a user requests modifications to generated content, such as changing the length, writing style, or description focus, conventional systems often regenerate content from scratch using ad hoc prompts manually composed by the user. Such manual intervention burdens the user, and the absence of an internal mechanism for generating secondary or additional prompt sentences reduces the system's ability to efficiently reuse prior analysis results and previously generated outputs. Consequently, the underlying computer system does not fully leverage its processing capabilities for adaptive, iterative content generation. Therefore, there is a need for an improved computer-implemented system and method that (i) systematically analyzes and integrates descriptive information and imaging information related to user memories, (ii) automatically constructs structured, context-rich prompt sentences for a generative AI model based on an integrated representation of the past event, and (iii) programmatically generates additional prompt sentences for controlled refinement of the generated content. Such a system should enhance the efficiency, accuracy, and controllability of the overall content generation pipeline, thereby improving the functioning of the computer system that orchestrates multiple external and internal AI services.

The specific processing by the specific processing unit 290 of the data processing device 12 in Example 1 is realized by the following means.

The present invention provides a server comprising a processor and a storage unit, the processor being configured to: receive, from a terminal operated by a user, descriptive information of a past event and imaging information related to the past event; store the descriptive information and the imaging information in the storage unit; analyze the descriptive information by using an external or internal natural language processing function to extract event summary information, subject information, time information, location information, and emotion information; analyze the imaging information by using an external or internal image analysis function to extract subject-matter information, scene information, object information, and facial expression information; generate an integrated representation of the past event based on the event summary information, the subject information, the time information, the location information, the emotion information, the subject-matter information, the scene information, the object information, and the facial expression information; construct a prompt sentence including the integrated representation and input the prompt sentence into a generative AI model to cause the generative AI model to generate new content based on the integrated representation; obtain the new content output from the generative AI model; and, in response to an instruction to change at least one of length, writing style, and description target of the new content, automatically generate an additional prompt sentence based on the new content and the integrated representation, re-input the additional prompt sentence into the generative AI model, and control the generative AI model to generate a revised version of the new content. This enables the computer system to perform structured multi-modal analysis of user inputs, to construct optimized prompt sentences that guide the generative AI model with reduced ambiguity, to iteratively refine generated content through programmatic prompt generation rather than manual user prompting, and thereby to improve the overall efficiency, accuracy, controllability, and technical reliability of AI-assisted content generation executed by the server.

The term “processor” refers to a hardware or virtual computing element, such as a central processing unit or a processing core provided by a computing environment, that executes instructions to perform operations described herein.

The term “terminal” refers to an information processing device operated by a user, such as a portable computing device, a stationary computing device, or a display device with input capability, that is configured to transmit data to and receive data from the server.

The term “user” refers to a human individual or an organization that operates the terminal to provide descriptive information and imaging information and to receive generated content.

The term “descriptive information” refers to information expressed in a natural language describing a past event, including text data that indicates circumstances, participants, times, locations, feelings, or other aspects of the past event.

The term “imaging information” refers to digital image data or other visual data associated with a past event, including still images, video frames, or other visual representations captured by an image acquisition device.

The term “storage unit” refers to a memory resource, such as a volatile memory, a non-volatile memory, or a combination thereof, configured to store descriptive information, imaging information, intermediate analysis results, prompt sentences, and generated content.

The term “natural language processing function” refers to a software or hardware component that analyzes natural language text to derive structured information, including functions for entity extraction, sentiment analysis, syntactic analysis, or semantic analysis.

The term “event summary information” refers to structured information that represents a condensed description of a past event derived from descriptive information, including an outline of what occurred and the main context of the event.

The term “subject information” refers to structured information indicating main entities involved in a past event, such as persons, groups, or objects, derived from descriptive information or imaging information.

The term “time information” refers to structured information indicating a time, date, period, or temporal relation associated with a past event.

The term “location information” refers to structured information indicating a place, region, environment, or spatial context associated with a past event.

The term “emotion information” refers to structured information representing an emotional state or sentiment associated with a past event, including degrees of positivity, negativity, or neutrality, derived from descriptive information.

The term “image analysis function” refers to a software or hardware component that analyzes imaging information to detect or classify features, including labels, objects, scenes, or facial expressions present in the imaging information.

The term “subject-matter information” refers to structured information indicating primary topics, themes, or main visual targets detected in imaging information.

The term “scene information” refers to structured information indicating an environmental or situational context of imaging information, such as indoor or outdoor scenes, landscapes, or event settings.

The term “object information” refers to structured information indicating physical items, persons, or elements detected in imaging information, identified by an image analysis function.

The term “facial expression information” refers to structured information indicating a type or likelihood of an emotional expression detected on a face in imaging information.

The term “integrated representation” refers to structured data that combines event summary information, subject information, time information, location information, emotion information, subject-matter information, scene information, object information, and facial expression information into a unified representation of a past event.

The term “prompt sentence” refers to a natural language instruction or query generated by the processor that includes at least part of the integrated representation and is configured to be input into a generative AI model to cause generation of new content.

The term “generative AI model” refers to a machine-implemented information processing model, such as a neural network language model, that receives a prompt sentence and outputs newly generated content that is not merely a retrieval of stored data.

The term “new content” refers to content generated by the generative AI model in response to a prompt sentence, including narrative text, descriptions, or other textual material derived from but distinct from the original descriptive information and imaging information.

The term “additional prompt sentence” refers to a prompt sentence generated after initial generation of new content, which is configured to instruct the generative AI model to modify, refine, or adapt the new content based on one or more change instructions or constraints.

The term “revised version of the new content” refers to content generated by the generative AI model in response to an additional prompt sentence, which constitutes an updated or modified form of previously generated new content.

The term “portable information processing device” refers to a terminal capable of being carried by a user, such as a handheld computing device or a mobile computing device, that includes at least a display function and an input function.

The term “communication network” refers to a wired or wireless network infrastructure, including local networks and wide-area networks, through which the terminal and the server exchange data.

In one embodiment, a server cooperates with one or more terminals operated by users to implement a system that generates new content based on past events using a generative AI model and prompt sentences. The server includes at least one processor, a main memory, a non-volatile storage device, and a network interface. The processor may be a multi-core central processing unit or a combination of a central processing unit and a graphics processing unit. The non-volatile storage device may be a solid state drive. The server executes an operating system such as a general-purpose server operating system and an application program implementing the functions described in the claims.

A terminal includes a display unit, an input unit, a local storage unit, a communication interface, and a local processor. The terminal may be a portable information processing device such as a smartphone or tablet computer, or may be a stationary information processing device such as a desktop computer. The terminal executes an operating system such as a mobile operating system or a desktop operating system and runs either a native application or a web browser to provide a user interface.

The user operates the terminal to input descriptive information of a past event and to select imaging information associated with the same past event. The terminal acquires the descriptive information as character data encoded in a character encoding scheme and acquires the imaging information as digital image data encoded in an image format. The terminal temporarily stores the descriptive information and the imaging information in the local storage unit and then transmits these data items to the server via the communication interface using a request format such as a structured text format or a multipart message.

The server receives the descriptive information and the imaging information via the network interface and stores the received data in the storage unit. The server assigns an internal identifier to each past event and stores, in association with the identifier, a record including a text field for the descriptive information, a list field for imaging information references, and fields for later storing analysis results. In an example, the server manages these records in a relational database system and stores imaging information in an object storage subsystem, while maintaining a mapping table that associates each event identifier with one or more object storage locations.

The server analyzes the descriptive information by invoking a natural language processing function. In one embodiment, the server uses an external natural language processing service via an application programming interface. In another embodiment, the server executes an internal natural language processing module implemented using a statistical model or a neural network model. The natural language processing function receives the descriptive information as input and outputs a structured representation such as a sequence of tokens, part-of-speech tags, named entities, sentiment scores, and dependency relations.

The server converts the output of the natural language processing function into event summary information, subject information, time information, location information, and emotion information. The server generates the event summary information by applying an extractive or abstractive summarization algorithm that selects sentences or phrases with high relevance scores computed from term frequency, inverse document frequency, or attention weights derived from a neural encoder. The server generates the subject information by selecting entity entries of types such as persons, groups, and objects from the named entity recognition output. The server generates the time information and the location information by parsing temporal expressions and spatial expressions using rule-based pattern matching and by mapping recognized expressions to normalized time stamps and standardized geographic descriptors. The server generates the emotion information by transforming sentiment scores and magnitudes into discrete emotion labels or continuous emotion vectors.

The server analyzes the imaging information by invoking an image analysis function. In one embodiment, the server calls an external image analysis service through an application programming interface. In another embodiment, the server executes an internal image analysis module implemented using a convolutional neural network and possibly additional layers. The image analysis function receives image pixel data or references to stored images as input and outputs labels, bounding boxes, scene categories, and facial attribute estimates.

The server converts the output of the image analysis function into subject-matter information, scene information, object information, and facial expression information. The server generates the subject-matter information by selecting labels or scene categories that appear with confidence scores above a predetermined threshold and that occur across multiple images belonging to the same event. The server generates the scene information by aggregating scene categories such as indoor, outdoor, beach, city, or home environment, and by computing a dominant category based on occurrence counts and weight factors. The server generates the object information by collecting object labels for detected regions and associating them with their detection scores. The server generates the facial expression information by mapping numerical emotion likelihoods for facial regions to discrete emotion labels and by estimating an overall emotional trend for the event based on a weighted aggregation of individual face detections.

The server generates an integrated representation of the past event by combining the event summary information, subject information, time information, location information, emotion information, subject-matter information, scene information, object information, and facial expression information into a structured data record. In one embodiment, the server represents the integrated representation as a hierarchical data structure in memory, including nodes for temporal context, spatial context, participant entities, emotional context, and visual context. The server stores the integrated representation in the storage unit in association with the event identifier.

The server constructs a prompt sentence for a generative AI model based on the integrated representation. The server includes, in the application program, a prompt composition module that receives the integrated representation as input and outputs a natural language text serving as a prompt sentence. The prompt composition module applies deterministic rules and template selection to convert structured fields into coherent text. For example, when the integrated representation indicates a “high school graduation trip” as an event type, a “seaside” as a location, an evening time period, and a positive emotional state with joyful facial expression information, the server selects a template corresponding to a nostalgic travel story and fills placeholders with specific elements.

In this example, the server generates a prompt sentence such as:
“Please write a vivid, nostalgic short story (about 800 words) based on the following memory: a joyful high school graduation trip to the seaside at sunset, with friends enjoying fireworks on the beach. Emphasize the warm feelings of friendship, the sound of the waves, the colors of the sunset, and the excitement of lighting fireworks together.”

In another example, when the integrated representation indicates a family birthday gathering in a home interior, the server generates a prompt sentence such as:
“Please create a heartfelt narrative (around 600 words) based on the following memory: a warm family gathering for the mother's birthday, where everyone meets again after a long time and celebrates around a homemade cake in a cozy living room. Emphasize the feeling of reunion, the details of the homemade cake, the conversations at the table, and the user's gratitude and happiness.”

In still another example, when a script format is selected, the server generates a prompt sentence such as:
“Write a short script for a 3-minute video based on this memory: a joyful high school graduation trip to the seaside at sunset, with friends enjoying fireworks on the beach. Include scene descriptions, camera directions, and dialogues between the main characters that reflect the nostalgic and joyful mood of the original event.”

The server inputs the prompt sentence into a generative AI model. In one embodiment, the generative AI model is a large-scale neural language model implemented as a transformer architecture. The generative AI model includes an encoder-decoder or decoder-only structure composed of multiple attention layers, feed-forward layers, and normalization layers. The model parameters include weight matrices for self-attention, cross-attention (if present), and intermediate projections. The model has been trained in advance using a corpus of text data and an objective function such as next-token prediction or masked language modeling. The training process includes computing a loss function, such as cross-entropy between predicted token distributions and ground-truth tokens, and updating model weights using gradient descent with optimization methods such as Adam. The training may also include data augmentation procedures such as random masking and sentence shuffling to improve generalization.

The server formats the prompt sentence and model parameters, including maximum output length, sampling temperature, and top-k or top-p settings, into a request payload that conforms to the interface specification of the generative AI model. When the model is executed on an external computing service, the server transmits the request via the network interface to the external service and receives output tokens as a response. When the model is executed locally on the server, the processor or the graphics processing unit performs the inference computation by iteratively applying the transformer layers to the tokenized prompt sentence and sampling output tokens according to the predicted probability distributions.

The server obtains the new content generated by the generative AI model as a sequence of text tokens, decodes the tokens into characters, and concatenates them into a text string. The server may apply post-processing operations such as trimming incomplete sentences, normalizing whitespace, or inserting paragraph boundaries based on punctuation patterns. The server stores the new content in the storage unit in association with the corresponding event identifier and prompt sentence.

The terminal receives the new content from the server via the communication interface, decodes the response payload, and displays the new content on the display unit. The user reads the new content and may input feedback via the input unit, such as a request to shorten the content, to change the writing style, or to increase the detail of specific aspects.

The server interprets the feedback as a change instruction and generates an additional prompt sentence. The server analyzes the new content and the integrated representation and determines which constraints to adjust. For example, when the user requests a shorter version, the server modifies a length parameter; when the user requests more detail about friends, the server increases the emphasis on subject information corresponding to friend entities. The server then composes an additional prompt sentence that references the prior content and specifies the requested modification. For example, the server generates a prompt sentence such as:
“Based on the previous story about the high school graduation trip to the seaside, please revise the story to be around 500 words and include more detailed conversations between the friends while still keeping the nostalgic and joyful mood.”

The server inputs the additional prompt sentence into the generative AI model using the same or updated model parameters, obtains a revised version of the new content, and returns the revised version to the terminal. By automatically generating additional prompt sentences in response to structured change instructions, the server reduces the burden on the user to manually craft complex prompts and enables a controlled, reproducible refinement process. The described architecture and processing provide technical effects that improve computer technology beyond mere automation of human tasks. The server reduces communication load and computation redundancy by performing pre-processing with specialized natural language processing and image analysis functions and by constructing compact, information-dense prompt sentences based on the integrated representation. Because the prompt sentence explicitly encodes structured event features, the generative AI model requires fewer iterations to produce content aligned with the user's context, thereby reducing the number of API calls and inference runs compared to systems that pass only raw input.

The server improves accuracy of content generation by integrating multi-modal features. The integrated representation encodes correlations between textual entities and visual labels, and the prompt composition module selects only consistent and high-confidence features. This causes the generative AI model to generate content that is more faithful to both the text and the images, reducing semantic errors and mismatches. The integrated representation also enables the server to apply filtering rules and weighting strategies not typically available to a human user, such as down-weighting features with low confidence scores or resolving conflicts through deterministic rules, thereby reducing variance and improving reproducibility.

The server improves computational efficiency by structuring data and controlling model invocation. The integrated representation functions as a compact cache of event-level information that can be reused across multiple generations and revisions. When the user requests a new variant, the server does not re-analyze the raw descriptive information and imaging information but instead modifies only prompt parameters and uses the existing integrated representation. This reduces repeated processing cost in the natural language processing function and the image analysis function and shortens end-to-end response time.

The server implements non-conventional processing flows compared to typical human prompting practices. For example, the server performs algorithmic selection of prompt templates and automatic parameterization based on machine-readable fields, rather than relying on arbitrary human phrasing. The prompt composition module uses rule-based assembly of sentences and structured substitution of placeholders, and may adjust word choices and sentence order based on ranking scores computed from feature importance values. This rule-based and data-driven prompt construction is tailored to the characteristics of the generative AI model, such as sensitivity to context window placement and positional encoding, and thereby improves the consistency and speed of model convergence to satisfactory outputs.

In another embodiment, the server incorporates an internal generative AI model trained specifically for the target domain. The server pre-trains a transformer-based language model on a corpus of narrative texts and fine-tunes the model using pairs of integrated representations and human-written stories. During fine-tuning, the server minimizes a loss function that measures divergence between model-generated text and reference text and updates model weights via backpropagation. The server may also introduce an auxiliary loss that penalizes deviations from key attributes encoded in the integrated representation, such as event type or emotional polarity, thereby aligning the model's internal representations with the structured features. This configuration further increases the reliability of generated content and strengthens the technical coupling between the integrated representation and the generative AI model.

In a variation, the server employs a modular architecture where the natural language processing function, image analysis function, prompt composition module, and generative AI inference module are implemented as separate services interconnected via an internal message bus. Each module adheres to defined data schemas for input and output, such as specific field sets for event summary information or object information. This modular design facilitates scaling and resource allocation across computing nodes. For example, the server may allocate a graphics processing unit-enabled node to the generative AI inference module and a central processing unit-optimized node to the natural language processing function, thereby optimizing hardware utilization and system throughput.

In another variation, the server applies additional optimization algorithms to reduce latency and resource usage. The server may pre-compute certain components of the integrated representation, such as static subject information and location information, and reuse them for multiple related events. The server may also implement caching of prompt sentence segments that are common across events with similar patterns, such as generic introductions for travel memories or family gatherings. By reusing cached segments, the server decreases the time required for prompt composition and reduces computational load.

In further embodiments, the terminal may include specialized input mechanisms, such as a stylus or speech input, and the server may include a speech recognition module that converts speech signals into descriptive information. The server then processes the converted text in the same manner as keyboard-entered descriptive information. In still other embodiments, the imaging information may include video segments, and the image analysis function may sample frames at regular intervals and apply video classification models that extend convolutional neural networks with temporal convolution or recurrent connections.

Through these configurations and variations, the server, terminal, and user cooperate to implement a concrete, technical system in which multi-modal analysis, structured integrated representations, and programmatic prompt sentence generation collectively improve the functioning of the underlying computer system, including processing speed, accuracy, data management, and communication efficiency, while enabling the generative AI model to produce high-quality, contextually aligned new content.

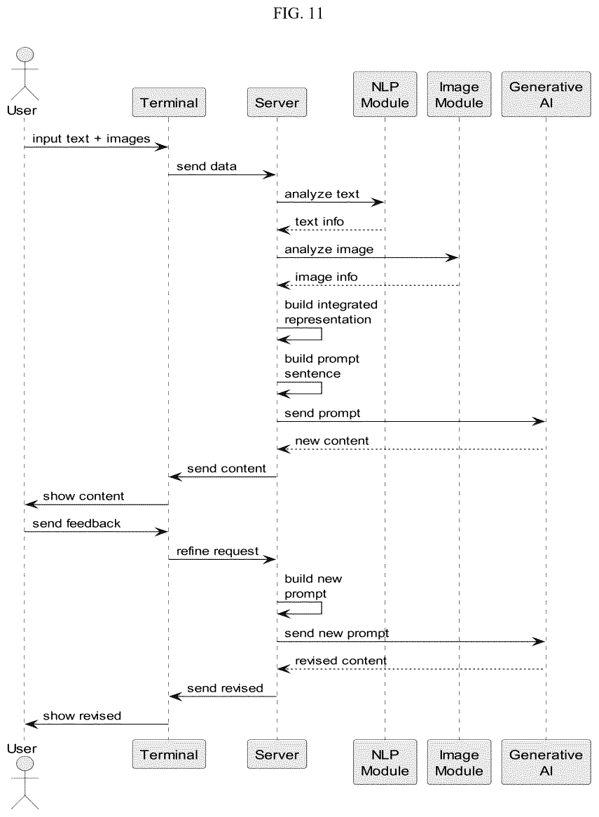

The following describes the processing flow using FIG. 11.

### Step 1

The user operates the terminal to input descriptive information and select imaging information. The user enters a description of a past event into a text input area and selects one or more images from local storage or captures new images using a camera function. The terminal receives the descriptive information as character data and the imaging information as digital image files. The terminal combines these inputs into a request payload by attaching the text and encoding the image files, for example as compressed image data. The output of this step is a structured payload containing the descriptive information and the imaging information ready to be transmitted to the server.

### Step 2

The terminal transmits the payload to the server. The terminal uses a communication library to open a secure network connection and sends the descriptive information and the imaging information as a request message. As input, the terminal takes the structured payload generated in Step 1 and wraps it in a network protocol format with headers and body. The terminal performs data encoding, such as converting text to a standard character set and encapsulating image data in a binary segment. The output of this step is a network request that reaches the server's network interface.

### Step 3

The server receives and stores the user data. The server accepts the incoming request through a network interface, parses the request to extract the descriptive information and the imaging information, and assigns a unique event identifier. As input, the server uses the raw network message including text and image data. The server performs data parsing, validation, and ID generation operations, then writes the descriptive information into a database record and stores the imaging information in an image storage subsystem, recording references in the database. The output of this step is a stored event record containing text, image references, and metadata indexed by the event identifier.

### Step 4

The server performs natural language processing on the descriptive information. The server retrieves the descriptive information from the database and passes it to a natural language processing function. As input, the server uses the text string representing the past event. The server tokenizes the text, applies part-of-speech tagging, named entity recognition, and sentiment analysis using a language analysis algorithm or a neural language model. The server computes feature vectors and scores, then aggregates them to derive event summary information, subject information, time information, location information, and emotion information. The output of this step is a structured text analysis result linked to the event identifier.

### Step 5

The server performs image analysis on the imaging information. The server obtains image references from the database and reads the corresponding image data from storage. As input, the server uses the raw pixel data or encoded image files for each image associated with the event. The server applies an image analysis function, such as a convolutional neural network, to detect labels, objects, scenes, and facial attributes. The server calculates confidence scores for detected elements and maps numeric outputs to semantic categories. The output of this step is a structured image analysis result including subject-matter information, scene information, object information, and facial expression information associated with the event.

### Step 6

The server generates an integrated representation of the past event. The server reads both the text analysis result and the image analysis result for the same event identifier. As input, the server uses structured fields such as event summary information, subject information, time information, location information, emotion information, subject-matter information, scene information, object information, and facial expression information. The server merges these fields into a unified data structure by aligning entities across modalities, resolving conflicts, and computing combined scores for consistent features. The output of this step is an integrated representation stored as a structured record that summarizes the event across text and images.

### Step 7

The server constructs a prompt sentence based on the integrated representation. The server passes the integrated representation to a prompt composition module. As input, the server uses the structured event summary, participant list, temporal and spatial context, emotional profile, and visual elements. The server selects a template according to desired output type, such as narrative, essay, or script, and fills placeholders with specific details drawn from the integrated representation. The server also inserts constraints such as target length and tone into the sentence. The output of this step is a complete prompt sentence that describes the past event and instructs subsequent content generation, for example: “Please write a vivid, nostalgic short story (about 800 words) based on the following memory: a joyful high school graduation trip to the seaside at sunset, with friends enjoying fireworks on the beach. Emphasize the warm feelings of friendship, the sound of the waves, the colors of the sunset, and the excitement of lighting fireworks together.”

### Step 8

The server invokes the generative AI model with the prompt sentence. The server formats the prompt sentence and model control parameters into an inference request. As input, the server uses the natural language text of the prompt sentence and numerical parameters such as maximum token count and sampling temperature. The server transmits this request to a generative AI model running locally or on an external service. The generative AI model performs neural network inference by transforming the prompt tokens through multiple attention and feed-forward layers to predict subsequent tokens. The output of this step, as observed by the server, is a sequence of generated tokens that form the new content.

### Step 9

The server post-processes and stores the new content. The server decodes the sequence of tokens into a text string. As input, the server uses the raw token sequence and the original prompt sentence. The server applies formatting operations, such as inserting line breaks, trimming incomplete endings, and optionally checking for language consistency and safety constraints. The server then writes the finalized new content into the database, linking it to the event identifier and the prompt sentence that produced it. The output of this step is a stored new content record ready to be delivered to the terminal.

### Step 10:

The server delivers the new content to the terminal. The server retrieves the stored new content and constructs a response payload. As input, the server uses the text of the new content and identification data such as the event identifier. The server encapsulates this data in a network response format and sends it through the network interface to the terminal. The output of this step is a response message containing the new content that reaches the terminal's communication interface.

### Step 11

The terminal presents the new content to the user. The terminal receives the response from the server and parses the payload. As input, the terminal uses the network response containing the new content string and any associated identifiers. The terminal updates its user interface by rendering the text in a scrollable view and possibly providing user controls for feedback, saving, or sharing. The output of this step is a displayed representation of the new content that the user can read and evaluate.

### Step 12

The user provides feedback for refinement, and the terminal sends refinement instructions to the server. The user operates controls on the terminal, such as buttons labeled “shorten,” “change style,” or “add more detail about friends,” or enters free-form instructions. The terminal captures these inputs as refinement parameters or text directives. As input, the terminal uses the user's feedback and the identifier of the current new content. The terminal constructs a refinement request conveying the desired changes and sends it to the server. The output of this step is a refinement instruction message transmitted to the server.

### Step 13

The server generates an additional prompt sentence and obtains revised content. The server receives the refinement instruction and retrieves the integrated representation and the previously generated new content. As input, the server uses the integrated representation, the prior new content, and the change parameters such as target length or focus area. The server adjusts prompt parameters and constructs an additional prompt sentence that instructs the generative AI model to revise the content, for example: “Based on the previous story about the high school graduation trip to the seaside, please revise the story to be around 500 words and include more detailed conversations between the friends while still keeping the nostalgic and joyful mood.” The server then calls the generative AI model with this additional prompt sentence, obtains a revised token sequence, decodes and post-processes it, stores the revised version, and returns it to the terminal. The output of this step is revised new content aligned with the user's refinement request.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for creating digital memory content from user-provided text and images typically treat the input merely as static media and apply only simple template-based slide shows or rule-based video assembly. Such systems do not deeply analyze the semantics of the user's narrative, do not recognize the user's emotional state, and do not construct structured instructions (prompt sentences) optimized for a generative AI model. As a result, the resulting content often lacks personalization, emotional coherence, and narrative quality, and the overall processing pipeline is not technically optimized for automated, scalable generation of personalized audiovisual content.

In addition, in many existing architectures, the processing of user input, the generation of narrative text by a generative AI model, the conversion of the narrative into narration audio, and the assembly of the audio with still images into motion image content are implemented as loosely coupled or manual steps. This leads to inefficiencies such as redundant data transfers between components, lack of synchronization between narration and visual sequences, and difficulty in systematically applying user-selected themes and background audio in a technically robust and repeatable manner.

Furthermore, there is a need, from the standpoint of computer technology, for an improved mechanism by which a server-side processor can: (i) automatically analyze user-provided language and image information to infer a psychological state; (ii) dynamically generate a structured prompt sentence tailored to that state and to the input language, so as to drive a generative AI model more effectively; and (iii) orchestrate downstream multimedia processing—speech synthesis, video editing, and theme application—in a coordinated pipeline. Without such a mechanism, servers cannot efficiently transform heterogeneous user input into high-quality, personalized motion image information while ensuring resource-efficient processing and consistent user experience across various client terminals, including portable information terminals. The technical problem to be solved is therefore to improve the functioning of the server and its multimedia processing pipeline so that it can automatically and reliably generate personalized motion image information by leveraging generative AI models and structured prompt sentences, while maintaining synchronization, scalability, and efficient use of computational and storage resources.

The specific processing by the specific processing unit 290 of the data processing device 12 in Application Example 1 is realized by the following means.

The present invention provides a server comprising a processor configured to acquire, by an information processing apparatus, language information describing a past experience from a user and image information related to the experience as input information, analyze a psychological state of the user based on the input information, construct, based on the analyzed psychological state and the language information, a prompt sentence for instructing a generative AI model to generate story information, input the prompt sentence to the generative AI model and obtain the story information, generate narration audio information by performing speech synthesis processing based on the story information, generate motion image information by using a video editing program based on the image information and the narration audio information, generate personalized motion image information by adding visual effects and background sound corresponding to atmosphere information and sound information selected by the user to the motion image information, and store the personalized motion image information in a storage device and make the personalized motion image information available to the user via a communication network. This enables an improvement in computer functionality by providing an integrated server-side processing pipeline that automatically transforms heterogeneous user input into synchronized, personalized motion image content through emotion-aware prompt sentence construction, efficient use of a generative AI model, and coordinated multimedia synthesis, thereby enhancing processing efficiency, scalability, and consistency of the generated audiovisual output.

The term “system” refers to a combination of one or more hardware devices and software components that cooperate to execute information processing related to acquisition, analysis, generation, storage, and provision of digital content.

The term “processor” refers to one or more processing units, such as a central processing unit or a graphics processing unit, capable of executing instructions to perform the functions described in the claims.

The term “information processing apparatus” refers to a hardware and software platform, including at least one processor and a memory, that executes programs for acquiring, analyzing, and processing input information from a user.

The term “user” refers to a human operator who provides input information, selects options such as atmosphere and sound, and views or shares generated digital content.

The term “language information” refers to character-based or text-based data that describes a past experience or memory of the user in one or more natural languages.

The term “image information” refers to digital visual data, including still images or equivalent visual representations, that are related to the user's past experience.

The term “input information” refers to a collection of data obtained from the user, including at least language information and image information, and optionally additional metadata associated with the user or the experience.

The term “psychological state” refers to an inferred emotional or affective condition of the user, such as happiness, nostalgia, sadness, or excitement, estimated from the content and characteristics of the input information.

The term “prompt sentence” refers to a structured instruction expressed in natural language, constructed based on the language information and the psychological state, and provided as input to a generative AI model to guide generation of story information.

The term “generative AI model” refers to a machine learning model configured to generate content, such as text, in response to input data, including the prompt sentence, by using learned parameters and probabilistic inference.

The term “story information” refers to narrative data, typically text, generated by the generative AI model in response to the prompt sentence and representing a coherent story based on the user's past experience.

The term “speech synthesis processing” refers to a processing operation that converts the story information, as text, into audio data representing a spoken narration using a text-to-speech technique.

The term “narration audio information” refers to digital audio data obtained by speech synthesis processing, representing a spoken version of the story information suitable for use as voice-over in motion image content.

The term “video editing program” refers to a software component or collection of functions configured to process image information and audio information to generate motion image information, including operations such as arranging, timing, and applying transitions to images.

The term “motion image information” refers to digital video data that represents temporally ordered visual content, generated by combining image information and narration audio information according to a time axis.

The term “personalized motion image information” refers to motion image information that has been customized based on user-specific selections, including atmosphere information and sound information, and that reflects the user's past experience and preferences.

The term “atmosphere information” refers to data indicating a desired style, mood, or visual theme for the motion image information, such as nostalgic, celebratory, or romantic, selected by the user.

The term “sound information” refers to data specifying one or more background audio elements, such as background music or ambient sound, selected by the user to be combined with the narration audio information.

The term “visual effects” refers to image processing operations applied to motion image information, including color adjustment, filtering, transitions, overlays, and other modifications that change the visual appearance to match atmosphere information.

The term “background sound” refers to audio content, such as background music or ambient noise, that is mixed with the narration audio information to enhance the emotional or atmospheric quality of the motion image information.

The term “storage device” refers to a hardware component or service, such as a local or networked memory or storage medium, that persistently stores digital data including personalized motion image information.

The term “communication network” refers to a wired or wireless data communication infrastructure, including the Internet or equivalent networks, used to transmit data between the server and one or more terminals.

The term “portable information terminal” refers to a movable electronic device, such as a smartphone or a tablet computer, that includes a display, input interface, processor, and communication interface, and is capable of running applications to interact with the system.

The term “display screen” refers to a visual output interface of a device, configured to present graphical user interfaces, images, and video content to the user.

The term “input screen” refers to a user interface element presented on the display screen that accepts user operations, such as text input, touch gestures, or selection of options related to language information, image information, atmosphere information, and sound information.

In one embodiment, a server cooperates with one or more terminals operated by a user to implement the claimed system. The server includes at least one processor, a main memory, a non-volatile storage device, and a network interface. The terminal includes at least one processor, a memory, a display, an input device such as a touch panel, and a wireless or wired communication interface. The user operates the terminal to provide language information and image information, and to receive and play back personalized motion image information.

The server executes an application program, for example, a web application implemented on a general-purpose operating system such as a server operating system running a web server and an application framework. The terminal executes a client application implemented as a native mobile application or a web-based application. The server and the terminal communicate via a communication network such as the Internet using a transport protocol such as HTTPS.

The server acquires language information and image information from the terminal as input information. The server receives, in a request message, language information describing a past experience of the user in a natural language, and image information including a plurality of still image files related to that experience. The server stores these data items in a storage device, for example in a database system and a file storage system. The server associates the stored language information and image information with a user identifier.

The server analyzes a psychological state of the user based on the input information. In one embodiment, the server uses a natural language processing module that performs tokenization, part-of-speech tagging, syntactic parsing, and semantic analysis on the language information. The server converts the language information into a sequence of tokens and maps each token to a numerical vector representation by using a word embedding model stored in memory. The server computes, for the entire sequence, one or more feature vectors representing sentiment and emotional tone by aggregating token-level vectors and feeding them into a sentiment classification model.

The server implements the sentiment classification model as a neural network, for example, a bidirectional recurrent neural network or a transformer-based classifier. The neural network is trained in advance on labeled text data, where each training sample includes a sentence or paragraph and a label representing an emotional category such as joy, sadness, nostalgia, or excitement. During training, the server minimizes a loss function such as cross-entropy loss between predicted emotional category probabilities and ground truth labels, and the server updates neural network weights by using a gradient-based optimization algorithm such as stochastic gradient descent or Adam. The server may perform data augmentation on the training data, for example by paraphrasing sentences using back-translation or synonym replacement, to improve robustness.

The server determines the psychological state by selecting, from the output probability distribution of the neural network, the emotional category with the highest probability, and by storing a numerical confidence score. The server may also calculate an emotional intensity value by applying a transformation to the probability distribution, such as computing an entropy-based measure. By using this neural network-based inference, the server achieves a higher accuracy and consistency in emotion recognition than simple rule-based or keyword-based methods, thereby improving the quality of subsequent processing steps.

The server constructs a prompt sentence for instructing a generative AI model to generate story information. The server stores, in the storage device, one or more prompt templates, each template being a string pattern including placeholders for emotional category, language type, and original language information. The server selects a template according to the detected psychological state and the language of the input. The server inserts, into the template, the name or description of the emotional category, and appends the language information itself, so that the generative AI model can refer to the actual text of the user's experience.

The server may construct, for example, the following prompt sentence in a text format:
“Please generate an emotional, first-person story suitable as a voice-over script for a short commemorative video. Focus on the user's feelings, the atmosphere, and important events. Use the same language as the episode text. Episode: Memories of visiting the seaside with friends on a high school graduation trip.”

The server may also construct another example prompt sentence in English:
“Generate a touching and nostalgic first-person narrative based on the following memory. Emphasize the emotions, sensory details, and the significance of the event for the user. The output will be used as a voice-over script in a short personalized video. Memory episode: Our high school graduation trip to the seaside with my best friends.”

The server stores the constructed prompt sentence in the database together with the psychological state and the original language information. Storing the prompt sentence as a structured record enables the server to audit and reuse the prompt sentence, and also to tune future prompt construction algorithms based on quality feedback.

The server provides the constructed prompt sentence to a generative AI model to obtain story information. In one embodiment, the server uses a large-scale language generation model implemented as a transformer neural network having multiple encoder and decoder layers, multiple attention heads, and a large parameter count. The server sends the prompt sentence to the generative AI model via an application programming interface. The generative AI model generates story information by computing successive output tokens, each token predicted based on the prompt and the previously generated tokens, using attention mechanisms and learned parameters. During training of the generative AI model, a language modeling objective is minimized, such as negative log-likelihood of correct next tokens on large corpora. Weights of the model are updated by backpropagation using gradient-based optimization.

The server specifies generation parameters such as maximum number of tokens, temperature, and top-k or top-p sampling thresholds when calling the generative AI model. By adjusting these numerical parameters, the server controls the length, diversity, and creativity of the story information. The server receives, from the generative AI model, a sequence of tokens representing the story information, and converts the tokens into a textual representation as a character string. The server may perform post-processing such as removing incomplete sentences at the end, normalizing punctuation, and ensuring that the story information uses the same language as the input language information.

The server generates narration audio information based on the story information. The server uses a speech synthesis engine that converts text into audio signals. In one embodiment, the server uses a neural text-to-speech model implemented as a sequence-to-sequence architecture with an attention mechanism, such as an encoder-decoder model mapping text to mel-spectrograms, combined with a neural vocoder model mapping spectrograms to waveforms. The server provides the story information, along with parameters specifying language, speaker type, speaking rate, and pitch, to the speech synthesis engine. The engine computes acoustic features and outputs digital audio data encoded, for example, as a waveform file or a compressed audio file.

The server stores the generated narration audio information in the storage device and records its file path or identifier. The server may also compute and store metadata such as the total duration of the narration audio by analyzing the audio file using a media processing library. This duration information is used, in later processing, to synchronize images with the narration audio.

The server generates motion image information based on the image information and the narration audio information by using a video editing program. In one embodiment, the server uses a multimedia processing library that supports reading, transforming, and encoding images and audio into a video container format. The server loads the image files associated with the input information, resizes them to a common resolution such as a high-definition resolution, and arranges them on a time axis according to a predetermined or computed time allocation. The server may store the arrangement as a timeline data structure, where each timeline element includes an image identifier, a start time, an end time, and a transition effect type.

The server uses the narration duration to compute an average display duration for each image, and adjusts durations to ensure that the sum of image durations matches the narration audio length within a threshold. For example, the server distributes any remaining time among images with higher emotional relevance as determined by analyzing the language information, thereby providing a technically improved synchronization between the semantic importance of content and visual duration. The server applies transition effects, such as cross-fades or zoom-ins, by instructing the video editing program to generate intermediate frames between images. The server then multiplexes the sequence of video frames with the narration audio track to produce motion image information stored as a video file in a container format.

The server generates personalized motion image information by adding visual effects and background sound corresponding to atmosphere information and sound information selected by the user. The server stores theme profiles in a configuration database, where each profile specifies visual effect parameters such as color grading curves, saturation and brightness adjustments, vignette parameters, and overlay graphics, and audio mixing parameters such as relative volume ratios between narration and background music. The server retrieves the theme profile corresponding to the selected atmosphere information, and retrieves a background music track from a library of audio files corresponding to the sound information.

The server applies the visual effect parameters by configuring the video editing program to execute color filters, overlays, and transitions according to the profile. For example, for a nostalgic atmosphere, the server may reduce color saturation, increase warm tones, and apply a slight blur at the frame edges. These operations modify pixel values according to predetermined formulas, thereby changing the overall appearance. The server applies the audio mixing parameters by processing the narration audio data and background music data with a digital signal processing pipeline that performs mixing, compression, and equalization.

For example, the server reduces the volume of the background music during segments where narration is present, by generating a gain envelope synchronized with the narration waveform.

The server stores the resulting personalized motion image information as a new video file, and records its location and associated metadata such as creation time, theme identifier, and user identifier. The server may generate and store a thumbnail image by extracting a representative frame from the video file. The server provides an interface through which terminals can request and retrieve information about available personalized videos. When the terminal requests playback, the server streams the personalized motion image information over the network, using an appropriate streaming protocol. The terminal decodes and displays the video and plays back the audio using its hardware-accelerated media components.

The server implements internal data structures and processing modules to improve computer performance relative to conventional systems. For example, the server stores intermediate results such as psychological state, prompt sentence, story information, narration audio path, and timeline configuration in a normalized database schema. This reduces redundant computation when the user requests re-generation with a different theme, because the server can reuse the story information and narration audio and only re-run the video editing and theme application stages. As a result, the server reduces computational load and storage I/O, leading to improved processing speed and lower resource utilization.

The server performs emotion recognition and prompt construction in a batched manner for multiple requests, allowing the server to use hardware accelerators such as graphics processing units or tensor processing units efficiently. By batching multiple prompt sentences and language information into a single inference call, the server reduces the number of network round-trips to the generative AI model and achieves reduced latency per request. This improvement in communication efficiency and model utilization is a technical effect beyond mere automation of human storytelling.

The server uses non-conventional rules in constructing the prompt sentence and organizing the multimedia pipeline. For instance, the server incorporates the inferred psychological state as a structured parameter in the prompt sentence, and maps specific emotional categories to explicit instructions within the prompt such as “emphasize nostalgia” or “highlight joy,” which influence the generative AI model's output distribution in a predictable way. This mapping allows the server to achieve more consistent emotional alignment between user input and generated story, which traditional template-based systems cannot realize.

The server controls the generative AI model and the video editing program in a coordinated manner. The server synchronizes story segmentation with image sequencing by analyzing the story information for sentence boundaries and keywords, and aligning important sentences with corresponding images. This alignment logic is implemented via a deterministic algorithm executed by the server, which scans the story text, assigns weights to sentences based on the presence of certain terms and emotional intensity measures, and then matches these sentences to images by using similarity measures between textual descriptions and stored image tags. This specific algorithmic structure improves the temporal coherence between audio and visual elements and provides a technical effect of reduced mismatch and higher perceived quality.

The server improves data management by using content-addressable storage for image and audio resources. The server computes hash values for each input image and generated audio file and stores them using hash-based identifiers. This facilitates deduplication across multiple user projects and reduces storage consumption, thereby improving storage efficiency. The server also maintains indexing structures that allow rapid retrieval of personalized motion image information based on user, theme, and creation time, enhancing overall system responsiveness.

The terminal operates as a thin client that offloads computationally intensive tasks to the server. The terminal records user interactions, displays forms for entering language information, and provides interfaces for selecting image information, atmosphere information, and sound information. The terminal sends compact, structured requests to the server and receives final or intermediate results. By distributing tasks in this way, the system reduces computational requirements on the terminal, thereby allowing execution on a wide range of portable information terminals with limited resources.

The user uses the system by entering a description of a past experience in a text field displayed on the terminal, selecting one or more images from a gallery, and choosing a desired atmosphere and background sound category. The user then requests generation of a personalized video. The user subsequently views the generated personalized motion image information on the terminal, and may choose to share the video via messaging or social platforms.

In other embodiments, the server may use alternative architectures for emotion recognition and language generation, such as convolutional neural networks or recurrent neural networks, or may implement the generative AI model locally instead of through a remote service. The server may also vary the video resolution, frame rate, and encoding parameters depending on the capabilities of the terminal or network conditions. The server may further support additional modalities such as short video clips as input, and may extend the psychological state model to include multi-dimensional affective representations rather than discrete categories.

Because the server implements specific data structures, neural network models, and multimedia processing pipelines that operate in a coordinated and optimized manner, the system achieves technical effects including improved processing speed through batching and reuse of intermediate results, improved emotional and temporal alignment of content through structured prompt sentence construction and sentence-image alignment algorithms, and improved storage efficiency through deduplication and indexing. These improvements enhance the functioning of the computer system itself and provide more efficient and accurate generation of personalized motion image information than conventional human-only or simple template-based workflows.

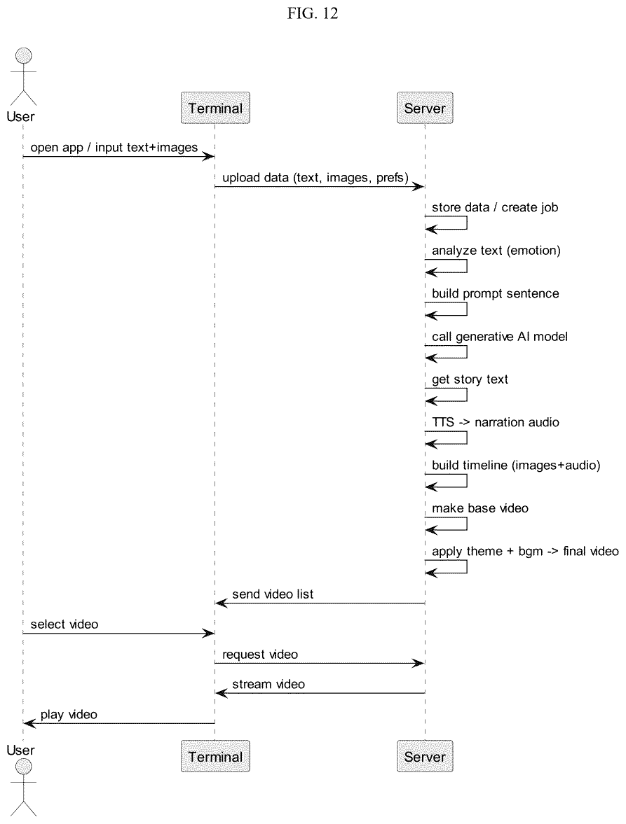

The following describes the processing flow using FIG. 12.

### Step 1

The user operates the terminal to launch an application and select a function for creating a personalized video. The user inputs language information describing a past experience into a text input field and selects one or more images from local storage as image information. The input of this step is raw user text and selected image files, and the output is a structured set of input information held in the terminal's memory (including text strings, file paths, and user-selected options such as atmosphere and sound categories).

### Step 2

The terminal validates the input information and transmits it to the server. The terminal checks that the language information is non-empty and that at least one image file is accessible, then packages the language information, image data, and user selections into a request message. The input of this step is the structured input information created in Step 1, and the output is a network request sent over a communication network containing encoded text data, binary image data, and metadata such as user identifier and selected atmosphere and sound categories.

### Step 3

The server receives the request and stores the raw input information. The server parses the request, extracts the language information and image data, and assigns a job identifier. The server stores the language information in a database and writes the image data to a storage device while registering their paths in association with the job identifier. The input of this step is the network request containing user text, image data, and metadata, and the output is a set of stored records and files representing the language information, image information, and job identifier persisted in the server's storage.

### Step 4

The server analyzes the psychological state of the user based on the language information. The server retrieves the language information from storage, tokenizes the text into words or subword units, and converts each token into a numerical vector using a stored embedding table. The server feeds the sequence of vectors into an emotion classification neural network to compute probabilities for multiple emotional categories. The input of this step is the stored language information associated with the job identifier, and the output is a psychological state record containing an emotional category label and numerical confidence values derived from the neural network's output.

### Step 5

The server constructs a prompt sentence for a generative AI model using the language information and the psychological state. The server selects a prompt template corresponding to the detected emotional category and language, then inserts the emotional description and the original user text into placeholder positions in the template. The server concatenates these elements into a single natural language instruction. The input of this step is the combination of the language information and the psychological state record, and the output is a complete prompt sentence stored as a text string that instructs the generative AI model how to generate story information.

### Step 6

The server sends the prompt sentence to the generative AI model and obtains story information. The server establishes a communication session with the generative AI model interface, transmits the prompt sentence along with generation parameters, and receives a sequence of tokens representing the generated story. The server converts the token sequence into a text string and performs normalization, such as trimming incomplete sentences and adjusting punctuation. The input of this step is the prompt sentence text and model configuration parameters, and the output is story information in the form of formatted narrative text associated with the job identifier.

### Step 7

The server generates narration audio information from the story information. The server passes the story text to a speech synthesis engine together with voice parameters such as language code, speaker profile, and speaking rate. The speech synthesis engine computes acoustic features and synthesizes a digital audio waveform. The server receives this audio data, encodes it into an audio file format, and stores it on the storage device while recording its file path. The input of this step is the story information text and voice configuration data, and the output is narration audio information saved as an audio file and referenced by a stored file path.

### Step 8

The server prepares a visual timeline from the image information and the narration audio duration. The server loads the stored image paths and determines the total duration of the narration audio by analyzing the audio file header or waveform. The server computes a time allocation for each image so that the sum of all image display intervals matches or closely approximates the narration duration. The server creates a timeline data structure listing each image, its start time, end time, and a selected transition effect. The input of this step is the set of image information paths and the narration audio duration, and the output is a timeline configuration describing how images are arranged along the time axis.

### Step 9

The server generates base motion image information using a video editing program. The server invokes the video editing program with the images, the timeline configuration, and the narration audio file as inputs. The video editing program resizes images to a common resolution, applies transition effects between images according to the timeline, and multiplexes the processed image frames with the narration audio track into a video container. The input of this step is the combination of image files, narration audio file, and timeline configuration, and the output is base motion image information stored as a video file representing a synchronized sequence of images with narration.

### Step 10

The server personalizes the motion image information by applying atmosphere information and sound information. The server retrieves a theme profile based on the selected atmosphere category and locates a background music track based on the selected sound category. The server configures the video editing program with visual effect parameters from the theme profile and audio mixing parameters specifying relative levels for narration and background music. The video editing program applies color adjustments, overlays, and other effects to the video frames and mixes the background music with the narration audio according to the mixing rules. The input of this step is the base motion image information, the theme profile derived from atmosphere information, and the background music audio, and the output is personalized motion image information stored as a themed video file including both narration and background sound.

### Step 11

The server stores and registers the personalized motion image information for later access. The server writes the themed video file to a storage device and records metadata such as user identifier, job identifier, creation time, and theme identifier in a database. The server may also generate a thumbnail image by extracting a representative frame from the video and store the thumbnail path. The input of this step is the personalized motion image video file and related parameters, and the output is a set of persistent records linking the personalized motion image information and its thumbnail to the corresponding user and making them available via query interfaces.

### Step 12

The terminal retrieves information about available personalized motion image information and displays it to the user. The terminal sends a query to the server including the user identifier, receives a list of video identifiers, titles, creation dates, and thumbnail paths, and downloads the thumbnail images. The terminal renders a list or grid of items on the display, each representing a personalized video. The input of this step is the user identifier and the server's metadata response, and the output is a graphical user interface on the terminal that visually presents selectable representations of stored personalized motion image information.

### Step 13

The terminal obtains and plays back a selected personalized motion image information file for the user. When the user selects an item in the display, the terminal requests the corresponding video file from the server and receives the video stream or file data. The terminal decodes the video and audio using its media playback components and outputs the synchronized audiovisual content through the display and speakers. The input of this step is the selected video identifier and the streamed personalized motion image data from the server, and the output is real-time playback of the personalized motion image information to the user, along with optional user actions such as pausing, seeking, or invoking sharing functions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional visual content generation systems that rely on generative AI models typically accept a single, static natural language prompt and optionally an image as input, and then output a one-shot image or video. Such systems suffer from several technical limitations in terms of how computing resources are used and how effectively the models are driven by user-provided data.

First, conventional systems do not systematically decompose user-provided episodic text and associated visual data into structured scene representation data. As a result, the processor cannot explicitly manage scene elements such as place, time, actions, subjects, and emotions as separate machine-readable parameters. This lack of structure forces the generative AI model to infer all relevant context from a monolithic prompt, which may cause inconsistent outputs, low controllability of the generation process, and redundant recomputation when only a subset of attributes needs to be changed.

Second, existing systems do not provide an integrated feedback-driven refinement loop in which user evaluation and correction request information are automatically analyzed and mapped back to specific scene parameters. Instead, users are typically required to manually re-enter or rewrite entire prompts, which leads to a trial-and-error cycle that is inefficient for both users and computing resources. The processor cannot effectively reuse prior scene analysis or partial generation results, and the generative AI model is repeatedly invoked with unrelated or overly broad prompt modifications.

Third, many known systems treat text and images independently and fail to integrate language processing technology and image processing technology into a unified representation before generating visual expressions. This separation hinders optimization of the generative AI model input, because semantic elements extracted from text (e.g., actions or emotions) and semantic elements extracted from images (e.g., subject categories or environment types) are not combined into a coherent scene representation. As a consequence, the generative AI model may underutilize available contextual information, leading to outputs that do not accurately reflect the user's past event or intended emotional tone.

Fourth, in the context of portable information terminals with limited computation and bandwidth, one-shot large-scale generation and repeated full re-generation impose unnecessary load on network interfaces and server-side accelerators. Without a mechanism for updating only those aspects of the scene representation that correspond to user feedback, the system cannot reduce redundant inference steps or manage generation parameters in a fine-grained manner.

Accordingly, there is a need for a computer-implemented system and method that improves the way a processor orchestrates language processing, image processing, scene representation generation, prompt sentence construction, and feedback-driven refinement for a generative AI model. Such a system should structure and integrate heterogeneous inputs (text and images), maintain and update machine-readable scene representation data, and iteratively control the generative AI model using updated prompt sentences derived from user feedback, thereby improving the efficiency, controllability, and reliability of visual expression generation on computing platforms including portable information terminals.

The specific processing by the specific processing unit 290 of the data processing device 12 in Example 2 is realized by the following means.

The present invention provides a server comprising a processor configured to receive, from a terminal, character information concerning a past event and visual information related to the past event, to apply language processing technology to the character information to extract scene elements, action elements, time elements, place elements, and emotion elements, to apply image processing technology to the visual information to extract subject categories, numbers of subjects, environment categories, and color tendencies, to generate scene representation data obtained by integrating the extracted elements, to automatically generate, on the basis of the scene representation data, a prompt sentence used as an input sentence for a generative AI model and including at least a position element, a time element, an action element, and an emotion element, to execute an image generation process or a video generation process using the generative AI model by using the prompt sentence and the visual information as inputs so as to generate a visual expression corresponding to the prompt sentence, to provide the visual expression to the terminal and receive, from the terminal, evaluation information or correction request information from a user regarding the visual expression, and to apply language processing technology to the evaluation information or the correction request information to extract change instructions concerning at least one of a time element, a color element, a subject element, and an action element, update the scene representation data and the prompt sentence based on the change instructions, and operate the generative AI model again on the basis of an updated prompt sentence to regenerate the visual expression. This enables the server to internally maintain and refine structured scene representation data, to generate and update prompt sentences in a machine-controlled manner without requiring users to manually rewrite prompts, to integrate text-derived and image-derived semantics before invoking the generative AI model, and to iteratively regenerate only those aspects of the visual expression that correspond to explicit change instructions, thereby improving the technical operation of the computer system in terms of generative AI control, resource utilization, and user-controllable visual content generation.

The term “processor” refers to one or more hardware-based information processing units, such as a central processing unit or an accelerator, that execute instructions to perform the functions described in the present specification.

The term “terminal” refers to an electronic information processing device, including but not limited to a stationary or portable device, that provides a user interface for inputting information and receiving visual expressions from a server.

The term “portable information terminal” refers to a terminal that is configured to be carried by a user, including but not limited to a mobile communication device, a handheld computing device, or a tablet-type device.

The term “character information” refers to digital text data representing a description of a past event, including words, phrases, and sentences input by a user through a user interface.

The term “visual information” refers to digital data representing visual content related to a past event, including but not limited to still images, image files, or other picture data provided by a user.

The term “language processing technology” refers to computer-implemented processing that analyzes character information, including operations such as tokenization, syntactic analysis, semantic analysis, entity extraction, and sentiment analysis.

The term “image processing technology” refers to computer-implemented processing that analyzes visual information, including operations such as object detection, subject recognition, environment classification, color analysis, and feature extraction.

The term “scene element” refers to an item of information that represents a component of a scene described in character information, including but not limited to place information, background information, and situational context.

The term “action element” refers to an item of information that represents an activity or behavior occurring in a scene, including but not limited to actions performed by persons, animals, or other subjects.

The term “time element” refers to an item of information that represents temporal aspects of a scene, including but not limited to time of day, date, season, or relative time context.

The term “place element” refers to an item of information that represents spatial aspects of a scene, including but not limited to a location, environment type, or setting.

The term “emotion element” refers to an item of information that represents an emotional state or affect associated with a scene, including but not limited to joy, sadness, excitement, or nostalgia.

The term “subject category” refers to a classification of a main subject appearing in visual information, including but not limited to a person, an animal, an object, or a landscape component.

The term “number of subjects” refers to numerical information indicating how many subjects of a given subject category appear in visual information.

The term “environment category” refers to a classification of a surrounding environment appearing in visual information, including but not limited to an indoor environment, an outdoor environment, a natural environment, or an urban environment.

The term “color tendency” refers to information representing a characteristic distribution or dominance of colors in visual information, including but not limited to dominant hues, saturation levels, and brightness levels.

The term “scene representation data” refers to structured data generated by integrating elements extracted from character information and visual information, the structured data including at least scene elements, action elements, time elements, place elements, emotion elements, subject categories, environment categories, and color tendencies.

The term “prompt sentence” refers to a natural-language text string generated by the processor and used as an input sentence to a generative AI model, the text string including at least one of a position element, a time element, an action element, and an emotion element describing a desired scene.

The term “generative AI model” refers to a machine-learned model configured to generate new data, including but not limited to an image or a video, based on an input such as a prompt sentence and optionally visual information.

The term “image generation process” refers to processing in which the generative AI model generates at least one still image corresponding to the content of a prompt sentence and optionally conditioned on visual information.

The term “video generation process” refers to processing in which the generative AI model generates a sequence of images or frames corresponding to the content of a prompt sentence and optionally conditioned on visual information, the sequence being displayable as a moving image or animation.

The term “visual expression” refers to generated visual content output by the system, including but not limited to a still image, a sequence of time-series images, or a moving image representing a scene based on a prompt sentence.

The term “evaluation information” refers to information provided by a user regarding a generated visual expression, including but not limited to an assessment, a rating, a comment, or an indication of satisfaction or dissatisfaction.

The term “correction request information” refers to information provided by a user requesting a modification of a generated visual expression, including but not limited to textual instructions specifying desired changes or adjustments to a scene.

The term “change instruction” refers to a directive extracted from evaluation information or correction request information, the directive specifying a modification of at least one of a time element, a color element, a subject element, and an action element in scene representation data or a prompt sentence.

The term “display control function” refers to processing executed by a terminal for presenting a visual expression, including operations such as rendering, playback control, and layout display.

The term “input control function” refers to processing executed by a terminal for receiving user inputs, including operations such as capturing character information, acquiring visual information, and receiving evaluation information or correction request information.

In one embodiment, a server cooperates with one or more terminals to generate, refine, and provide visual expressions based on user-provided character information and visual information concerning a past event. The server includes at least one processor, a main memory, a non-volatile storage device, a network interface, and optionally one or more hardware accelerators such as graphics processing units. The terminal includes an input/output interface, a display unit, and a communication module. The user operates the terminal to supply inputs and to view generated outputs.

The server executes a program stored in the non-volatile storage device and loaded into the main memory. The program can be implemented using a general-purpose programming language such as a scripting language running on a runtime environment. The server can run a web application framework for request handling and data management, and can access a relational database management system such as a structured query language database, as well as an object storage service for binary files. The server can further access a natural language processing library such as a tokenization and parsing toolkit or a neural network library for language models, an image processing library such as an image manipulation toolkit, and a machine learning framework such as a tensor computation framework for inference of a generative AI model.

The terminal operates a user interface implemented, for example, as a native application on a mobile operating system or as a web application in a browser. The terminal presents text input controls, file selection dialogs, buttons, sliders, and other interface widgets that allow the user to enter character information describing a past event, to select visual information in the form of one or more image files stored in a local storage unit, and to submit such information to the server. The terminal can be a portable information terminal such as a smartphone or tablet computer, or a stationary terminal such as a desktop computer.

The server receives character information from the terminal via a network interface using a communication protocol such as a secure hypertext transfer protocol. The character information is composed of sentences that describe a past event, including expressions of who was present, where the event occurred, at what time or season it occurred, and what activities and emotions were involved. The server also receives visual information, typically encoded as digital image files. The server stores the received character information as text records in the database and the received visual information as binary objects in the object storage, and maintains associations between the text records and the binary objects using identifiers.

The server applies language processing technology to the character information. In one implementation, the server uses a pipeline built on a natural language processing library. The server first normalizes the text (for example, converting character encoding, unifying whitespace, and standardizing punctuation). The server then performs tokenization to segment the text into tokens, and applies part-of-speech tagging and dependency parsing to determine grammatical relationships. The server further applies named entity recognition to extract place names, time expressions, person references, and other entities.

The server uses a sentiment analysis model implemented on a neural network architecture such as a transformer. The neural network can include multiple attention layers, feed-forward layers, and layer normalization components. The server inputs the tokenized text and obtains an embedding sequence, aggregates the embeddings to a sentence-level representation, and outputs probabilities over predefined emotion categories such as joy, sadness, anger, and nostalgia. The server selects an emotion element by choosing the category with the highest probability and optionally uses the probability distribution as an intensity measure.

The server maps tokens and entities into semantic categories. The server assigns tokens to scene elements (e.g., environment descriptors), action elements (e.g., verbs describing activities), time elements (e.g., “summer evening”), and place elements (e.g., “beach,” “mountain”). The server uses rule-based mapping tables and pattern matching to link certain lexical patterns to semantic roles. For example, the server can use a domain-specific lexicon that associates words such as “beach,” “sea,” or “shore” with a location category, and expressions such as “laughing together” or “having fun” with a positive emotion-related action element. This explicit mapping into scene elements, action elements, time elements, place elements, and emotion elements forms part of a structured representation of the text.

The server applies image processing technology to the visual information. The server loads each image using an image processing library. The server resizes images, normalizes color channels, and feeds the images into a pre-trained computer vision model such as a convolutional neural network or a vision transformer. The computer vision model has been trained on large-scale labeled image datasets and can output one or more of subject categories (e.g., “person,” “vehicle,” “tree”), environment categories (e.g., “indoor,” “outdoor,” “beach,” “forest”), and the number of detected subjects using object detection heads and classification heads. The server also computes color histograms over color spaces and calculates dominant color tendencies (e.g., high proportion of warm hues versus cool hues). The server may further use a face detection model to count faces and infer approximate group sizes.

The server integrates the results of the language processing and image processing into scene representation data. The scene representation data can be implemented as a structured data object such as a nested dictionary or record with named fields. Typical fields include at least: location, time_of_day, season, main_characters, activities, emotion, subject_categories, number_of_subjects, environment_category, dominant_colors, and additional scene attributes derived from both character information and visual information. By storing both text-derived semantics and image-derived semantics in a unified data structure, the server enables downstream modules to access and modify specific attributes without re-parsing the original text or re-analyzing the images.

The server uses the scene representation data to automatically generate a prompt sentence to be applied as an input to a generative AI model. The server concatenates elements of the scene representation using templates and generation rules stored in memory. For example, the server may fill a template of the form: “A [emotion] [season or time_of_day] at a [location] with [main_characters] [activities], [environment details], and [color description].” The server obtains a concrete prompt sentence such as:
“A joyful summer afternoon at a sandy beach with close friends laughing and playing in the waves, bright blue sky, sparkling water, and warm sunlight.”

The server can add rendering preferences such as “in a semi-realistic style, vivid colors, high resolution” to guide the generative AI model. The generative AI model is a machine-learned model configured to generate images or videos from text and optionally from reference images. In one implementation, the generative AI model is a diffusion model. The diffusion model includes a text encoder component, such as a transformer-based encoder, and a denoising network, such as a U-Net with attention layers. The server converts the prompt sentence into an embedding vector using the text encoder, initializes random noise in a latent space, and repeatedly applies the denoising network under guidance from the text embedding to generate a latent representation that is then decoded into pixel values.

In another implementation, the generative AI model is a generative adversarial network, including a generator neural network and a discriminator neural network, both of which are trained with adversarial loss. The server inputs the prompt sentence into a conditioning network that controls the generator, and the generator produces images conditioned on the textual embedding. The discriminator compares generated images with real images and outputs feedback during training. Although the described system mainly uses pre-trained generative AI models for inference, the same architecture and training process can be used in a training phase.

The server executes an image generation process or a video generation process using the generative AI model. When generating a still image, the server sets parameters such as image size, number of denoising steps, classifier-free guidance scale, and random seed. When generating a video, the server either uses a multi-frame generative model or sequentially generates multiple frames, where each frame is conditioned on the same prompt sentence and optionally on previous frames (for temporal coherence). The server can supply the visual information as an “init image” to an image-to-image or video-to-video pipeline, in which the generative AI model starts from the user's image and modifies colors, lighting, or additional elements while preserving some structural aspects.

The server produces a visual expression in the form of a generated image file or a generated video file. The server stores the visual expression in the object storage, registers metadata in the database, and returns a reference (such as a URL) to the terminal. The terminal retrieves the visual expression and displays it on the display unit using renderers appropriate to the file format. The user can thus view, zoom, and otherwise interact with the generated visual expression.

The user can provide evaluation information and correction request information via the terminal. The terminal displays a feedback interface, including a text field and optionally pre-defined options. The user may enter instructions such as:
“Please change the scene to sunset, add more orange and pink in the sky, and show us playing volleyball instead of just standing.”

The terminal transmits this feedback to the server. The server applies language processing technology to the feedback. The same or a different natural language processing pipeline identifies modification operators (“change,” “add,” “show”) and target attributes (“sunset,” “orange and pink in the sky,” “playing volleyball”). The server interprets these as change instructions affecting the time element (changing the time_of_day field to “sunset”), the color element (adjusting dominant_colors toward warm hues), and the action element (replacing “standing” with “playing volleyball” in the activities field).

The server updates the scene representation data accordingly and reconstructs an updated prompt sentence. For example, the server generates:
“A joyful summer sunset at the beach with close friends playing volleyball on the sand, orange and pink sky, warm glowing light, and energetic motion.”

By performing updates at the level of structured data rather than requiring the user to craft a full new prompt, the server can maintain consistency across versions and avoid losing information that does not need to change, such as the identities or number of subjects. The server then executes the generative AI model again using the updated prompt sentence, optionally taking the earlier visual expression as an init input for refinement, and regenerates the visual expression. The cycle of user feedback, structured update, prompt regeneration, and generative inference can be repeated multiple times.

The server thereby improves computer technology in several respects. First, by generating and maintaining explicit scene representation data, the server allows selective updates to elements such as time, place, and emotion without re-processing all original inputs, which reduces unnecessary computation in both the language processing pipeline and the generative AI model inference. Second, by integrating character information and visual information into a unified structure, the server can produce more accurate prompt sentences, which improves the quality and consistency of generative outputs and reduces the need for repeated trial-and-error generations. Third, by mapping user feedback to precise change instructions with a rule-based and model-based interpretation, the server avoids manual editing of long prompt sentences and permits algorithmic optimization of prompt content for the generative AI model.

In terms of neural network details, the server can use supervised learning to train the sentiment analysis model and other classification models, using labeled corpora of text annotated with emotion, time-of-day descriptors, and scene labels. The loss function may be categorical cross-entropy over class labels, with regularization terms to prevent overfitting. During training, the server adjusts network weights using gradient descent and backpropagation, updating parameters until convergence criteria are met. For the generative AI model, the server (or an external training system) can employ a diffusion objective that minimizes the difference between denoised outputs and ground-truth image samples at multiple noise levels. Data augmentation techniques such as random cropping, color jitter, and horizontal flipping can be used when preparing training examples.

By storing scene representation data in a structured form, the server can organize and index data efficiently in the database, for example by indexing on fields such as emotion or environment_category. This improves retrieval performance when the system is extended to support reuse of prior scenes or recommendation of similar visual expressions. Because only incremental changes to the representation are carried forward in response to feedback, the system can reduce network traffic between the terminal and the server by exchanging compact textual feedback and structured change instructions rather than repeatedly transmitting large image files.

The terminal and the server cooperate using communication protocols and predefined data formats. The server can provide application programming interfaces that define request and response formats for character information, visual information, visual expressions, and feedback. The terminal implements a client that adheres to these formats and can be distributed as an application. The described transformations—from raw user inputs to structured scene representation data, to a prompt sentence, to a generated visual expression, and back to updated representation via feedback—constitute technical operations that depend on and improve the functioning of the computing system as a whole, particularly in the way the generative AI model is controlled and how computational resources on the server-side accelerators are managed.

In alternative embodiments, the server can use different architectures for the generative AI model, such as an autoregressive video model or a hybrid model that combines a sequence model over frames with a diffusion model within frames. The server can also adapt the prompt sentence generation rules by using a learned language model that refines template-based prompts. In another variant, the server can emphasize time-series coherence by encoding the scene representation into a latent sequence and using recurrent architectures or temporal attention mechanisms to produce smooth motion in the generated video.

In all these embodiments, the server, the terminal, and the user roles are defined as follows: the server performs heavy computation, data integration, and generative processing; the terminal provides input and output interfaces and handles display and basic interaction; and the user supplies subjective and contextual information and receives visual expressions. The described configuration and operations allow the system to implement the claimed invention in a manner that can be reproduced by a person skilled in the art using commonly available hardware and software components.

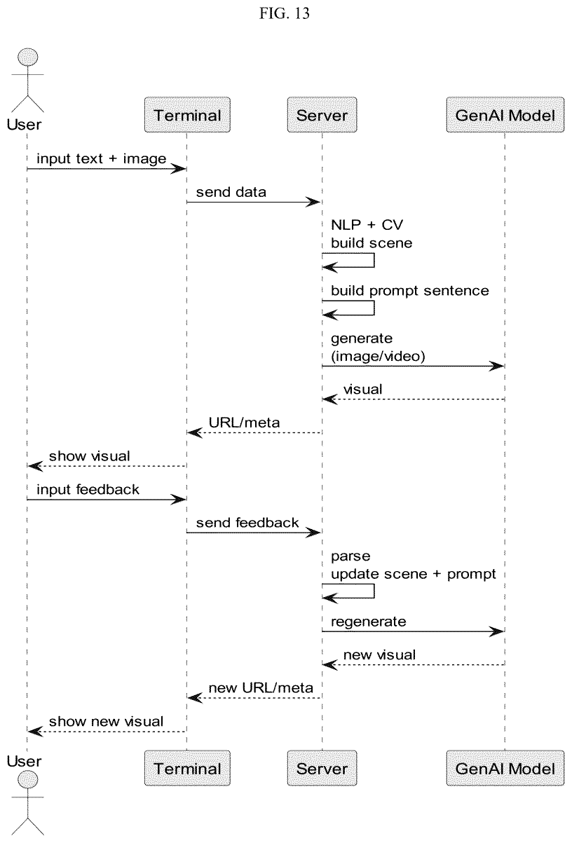

The following describes the processing flow using FIG. 13.

### Step 1

User operates the terminal to input character information and select visual information. User types text describing a past event into a text input field on the terminal, and selects one or more image files from local storage using a file selection dialog or gallery interface. As input, the terminal receives raw character information (text strings) and raw visual information (image files). As output, the terminal holds these inputs in memory and prepares them for transmission to the server by packaging the text and file references into a request data structure.

### Step 2

Terminal transmits the character information and visual information to the server. Terminal takes the character information and visual information as input and encodes the text into a character string in a standard encoding format and the images into binary streams (e.g., JPEG or PNG). Terminal then constructs a network request, for example an HTTPS POST with multipart/form-data, containing the encoded text and binary image data. As output, the terminal sends this network request to a designated server endpoint and may display a progress indicator to the user.

### Step 3

Server receives and stores the raw input data from the terminal.

Server accepts the network request as input and parses the request body using a web framework. Server extracts the character information as a text string and each piece of visual information as a binary image stream. Server then writes the image binaries to a storage subsystem and records metadata (such as file paths, timestamps, and user identifiers) in a database. As output, the server produces normalized text data stored in memory and persistent references to stored image data.

### Step 4

Server preprocesses the character information.

Server takes the normalized text data as input and performs text cleaning operations, including converting character encodings, removing extraneous whitespace, and unifying punctuation. Server applies language detection to determine the language of the input and selects appropriate language models. As output, the server produces cleaned character information and a language code, both stored as structured text objects ready for further analysis.

### Step 5

Server performs language processing on the character information.

Server receives the cleaned character information as input and feeds the text into a natural language processing pipeline. Server tokenizes the text into tokens, assigns part-of-speech tags, and computes dependency relations. Server then applies named entity recognition to detect entities such as places, times, and person references, and runs a sentiment analysis model to compute probabilities over emotion categories. Using these intermediate results, the server maps phrases to scene elements, action elements, time elements, place elements, and emotion elements. As output, the server generates a set of extracted linguistic features and semantic labels organized in an intermediate semantic representation.

### Step 6

Server performs image processing on the visual information.

Server takes as input the stored image references and loads the image data into memory using an image processing library. Server resizes and normalizes each image, and passes the processed images into a computer vision model to detect subject categories, environment categories, and the number of subjects. Server computes color histograms to determine dominant color tendencies. As output, the server produces image-derived semantic features, including subject categories, numbers of subjects, environment categories, and color tendencies, stored as structured data elements.

### Step 7

Server integrates text-derived and image-derived semantics into scene representation data.

Server uses the text-derived semantic representation and the image-derived semantic features as input. Server merges these inputs by aligning elements such as locations, activities, and emotional tone with detected visual subjects and environments. Server populates a scene representation data structure with fields such as location, time_of_day, season, main_characters, activities, emotion, subject_categories, number_of_subjects, environment_category, and dominant_colors. As output, the server holds a unified scene representation object that encapsulates both linguistic and visual semantics.

### Step 8

Server generates a prompt sentence based on the scene representation data.

Server uses the scene representation object as input and applies template-based rules and string composition operations to construct a descriptive natural language sentence. Server selects values from the scene representation fields and inserts them into one or more pre-defined templates. For example, the server may output a prompt sentence such as: “A joyful summer afternoon at a sandy beach with close friends laughing and playing in the waves, bright blue sky, sparkling water, and warm sunlight.” As output, the server obtains a prompt sentence string that encodes scene elements, action elements, time elements, place elements, and emotion elements in human-readable form suitable for input to a generative AI model.

### Step 9

Server prepares inputs and parameters for the generative AI model.

Server takes as input the generated prompt sentence and the stored visual information references. Server selects a generative AI model type (e.g., image generation or video generation) and sets configuration parameters including resolution, number of inference steps, guidance scale, random seed, and whether to use an input image as an initialization. Server then converts the prompt sentence into a tokenized form and, if required by the model, pre-encodes the prompt into an embedding vector using a text encoder. As output, the server produces a fully specified model inference request object containing the prompt sentence, optional reference images, and model parameters.

### Step 10

Server executes the image generation or video generation process using the generative AI model.

Server feeds the model inference request object as input to the generative AI model running on a hardware accelerator or accessed via a network API. The generative AI model processes the prompt embedding and, in the case of a diffusion model, iteratively refines randomly initialized latent variables using the denoising network guided by the prompt embedding and optional image conditioning. In the case of a video generation process, the model generates a sequence of latent representations across time and decodes them into frames. As output, the server receives generated image data or a sequence of frames representing a visual expression corresponding to the prompt sentence.

### Step 11

Server post-processes and stores the generated visual expression.

Server uses the raw generated image data or frame sequence as input. Server converts the data into standard media formats, for example encoding images as PNG files or encoding a frame sequence into a compressed video file. Server writes these files to storage and records metadata such as the associated prompt sentence, scene representation identifier, generation timestamp, and version number in the database. As output, the server produces persistent file locations or URLs and a corresponding metadata record for the generated visual expression.

### Step 12

Server provides the generated visual expression to the terminal.

Server takes as input the file location or URL of the visual expression and associated metadata. Server constructs a response message that includes the URL, basic properties (e.g., resolution, duration), and identifiers needed for later feedback association. Server sends this response via the network interface to the terminal. As output, the server transmits a structured response that enables the terminal to retrieve and display the generated visual expression.

### Step 13

Terminal retrieves and displays the generated visual expression.

Terminal uses the response from the server as input, parses the URL and metadata, and issues a media request to download the image or video file. Terminal decodes the media stream and renders it on the display unit, creating an image view or launching a video player control. The terminal may also generate playback controls such as play, pause, and seek. As output, the terminal presents the visual expression on the screen, making it observable to the user.

### Step 14

User evaluates the visual expression and inputs feedback via the terminal.

User observes the displayed visual expression and determines whether it matches the intended memory and emotional tone. User then operates feedback controls on the terminal, such as a text area and selection widgets, to describe desired changes. As input, the terminal captures free-text feedback and optional structured parameters (e.g., sliders or checkboxes). As output, the terminal holds feedback data that encodes the user's evaluation information and correction request information.

### Step 15

Terminal transmits the feedback to the server.

Terminal takes the captured feedback data and associated identifiers for the visual expression as input. Terminal encodes the text and structured feedback into a request body, such as a JSON object, and sends this body to a server feedback endpoint over a secure communication channel. As output, the terminal delivers a feedback request that the server can process to update the visual expression.

### Step 16

Server analyzes the feedback and derives change instructions.

Server receives the feedback request as input and retrieves the corresponding scene representation data and prompt sentence using identifiers from the database. Server processes the feedback text using language processing technology, applying tokenization, part-of-speech tagging, and semantic parsing to detect modification verbs and target attributes.

Server maps expressions such as “change to sunset,” “add more orange and pink in the sky,” or “show us playing volleyball” to change instructions affecting time elements, color elements, subject elements, and action elements. As output, the server generates structured change instructions that specify which fields in the scene representation data must be updated and how.

### Step 17

Server updates the scene representation data and regenerates the prompt sentence.

Server uses the current scene representation data and the change instructions as input. Server applies the change instructions by modifying fields such as time_of_day from “afternoon” to “sunset,” adjusting dominant_colors toward warm hues, and replacing activities with “playing volleyball.” After updating the scene representation data, the server regenerates a new prompt sentence using the same template-based or rule-based process. For example, the server may output: “A joyful summer sunset at the beach with close friends playing volleyball on the sand, orange and pink sky, warm glowing light, and energetic motion.” As output, the server produces updated scene representation data and an updated prompt sentence reflecting the user's requested changes.

### Step 18

Server re-invokes the generative AI model to regenerate the visual expression.

Server takes as input the updated prompt sentence, the updated scene representation data, and optionally the previously generated visual expression as a reference image or video. Server creates a new inference request with updated parameters, possibly enabling image-to-image or video-to-video processing so that composition and subject identity are preserved while time, colors, and actions are changed. Server then performs the generation process again using the generative AI model, producing a refined visual expression. As output, the server obtains a new image or video file that incorporates the user's feedback and can be stored and delivered to the terminal in the same manner as the initial result.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that utilize machine learning typically treat user-provided text and images as simple inputs to a single generative model, and produce static or pre-scripted videos without structural understanding of the narrative and without any dynamic adaptation to the viewer's emotional state. As a result, such systems exhibit several technical limitations from a computer-technology perspective.

First, conventional systems generally lack a pipeline that converts unstructured multimodal input (free-form text describing a past experience and arbitrary associated images) into structured scene-level data suitable for downstream visual generation. Without explicit extraction of semantic information such as entities, locations, temporal structure, and per-scene emotional tendencies, the generative process cannot effectively align the behavior of multiple models (for example, a text generative model and an image generative model). This leads to technically suboptimal resource utilization on the server side and to inconsistencies between the generated narrative and the generated images or animations.

Second, known systems typically do not construct prompt sentences in a systematic and machine-controlled manner. Instead, they rely on a single, manually written prompt or on a direct pass-through of user text into a generative AI model. This lack of structured prompt construction prevents the system from programmatically controlling generation constraints such as scene composition, expression style, or emotional emphasis. Consequently, server-side inference for generative AI models is not context-optimized, and the quality and relevance of the generated narrative and visual content can vary widely, increasing the need for additional computation or human post-processing.

Third, conventional architectures usually generate visual content in a monolithic step and do not expose intermediate representations such as scene pieces or structured metadata to subsequent processing modules. This limits the ability of the server to orchestrate multiple heterogeneous software components, such as natural language processing engines, image generative models, and moving-image editing engines, in a coordinated and programmable way. The result is increased processing latency, duplicated computations, and reduced scalability when generating large volumes of personalized content.

Fourth, typical systems treat the user's emotional state, if considered at all, as a static attribute derived only from the input episode. They generally do not integrate a feedback loop in which real-time facial expression or audio information from the user's terminal during playback is used to dynamically adjust technical parameters of the moving-image content. In particular, known systems lack a server-side mechanism to ingest real-time affective signals and to translate them into dynamic adjustments of color tone, brightness, acoustic characteristics, and other playback parameters. This absence of an emotion-aware control layer over the playback pipeline leads to a rigid presentation that cannot adapt to the viewer's current psychological state.

Fifth, virtual reality environments that are generated from narrative content often rely on handcrafted scripts and fixed camera paths. Existing systems rarely integrate structured narrative data and real-time emotional feedback into the control logic of a three-dimensional virtual space rendered for a head-mounted display. As a result, camera viewpoint, lighting conditions, and acoustic conditions in such virtual environments are not dynamically controlled in accordance with the user's gaze direction, position, and emotional state. This reduces the technical effectiveness of the VR rendering engine and the interactivity achievable with the underlying graphics pipeline.

Accordingly, there is a need for an improved computer-implemented system that: (i) automatically transforms unstructured multimodal user input into structured scene-level data; (ii) programmatically constructs optimized prompt sentences for different generative AI models; (iii) orchestrates text generation, image generation, and moving-image editing in a modular and data-driven pipeline; and (iv) incorporates both initial and real-time emotional information to dynamically control rendering parameters of two-dimensional and three-dimensional visual content. Such a system should improve the efficiency, consistency, and adaptability of the entire generative pipeline, thereby enhancing the technical performance of the server-side content generation and playback infrastructure.

The specific processing by the specific processing unit 290 of the data processing device 12 in Application Example 2 is realized by the following means.

The present invention provides a server comprising a processor configured to receive, from an information processing terminal, description information representing a past experience of a user and visual information associated with the past experience, to analyze the description information and the visual information by using a natural language processing technique and an image analysis technique in order to extract semantic information and emotional information, to construct, based on the semantic information and the emotional information and optionally on an instruction sentence received from the information processing terminal, a structured prompt sentence for input to a first generative artificial intelligence model so as to cause the first generative artificial intelligence model to generate a narrative text, to re-analyze the generated narrative text by using the natural language processing technique in order to divide the narrative text into a plurality of scene pieces and to generate, for each scene piece, structured data including at least an appearing entity, a background environment, a temporal structure, and an emotional tendency, to construct, based on the structured data and the visual information, a further prompt sentence for input to an image generative artificial intelligence model so as to cause the image generative artificial intelligence model to generate, for each scene piece, a still visual content or a short-time visual content, to arrange the still visual contents or the short-time visual contents in a time direction and to use a moving-image editing program to automatically construct moving-image content having a predetermined resolution and a predetermined frame rate while applying color tones, screen effects, and audio information corresponding to the emotional information, to store the moving-image content in a storage device together with related metadata and to generate and provide an access identifier for the moving-image content to the information processing terminal, and to receive, during playback of the moving-image content, facial expression information or audio information of the user from the information processing terminal, to estimate a current emotional state of the user by using an emotion analysis model, and to dynamically adjust at least one of color tone, brightness, acoustic characteristics, and playback parameters of the moving-image content according to the current emotional state, and further configured, in some embodiments, to generate a three-dimensional virtual space based on the structured data, to render a virtual-reality environment for a head-mounted display by using a visual display engine, and to control a camera viewpoint, lighting condition, and acoustic condition in the virtual-reality environment in accordance with at least one of gaze direction, position information, and the current emotional state of the user. This enables the server to implement a technically improved, modular generative pipeline that transforms unstructured multimodal input into structured scene-level data, optimizes prompt sentences for different generative AI models, coordinates heterogeneous generation and editing engines, and adaptively controls rendering parameters in real time based on emotional signals, thereby improving consistency, efficiency, responsiveness, and personalization of computer-generated visual and virtual-reality content.

The term “information processing terminal” refers to an electronic device capable of inputting, transmitting, receiving, and displaying digital data, such as a handheld terminal, a mobile communication device, a tablet device, a personal computer, or a head-mounted display device.

The term “description information” refers to text data or equivalent symbolic data that represents a user's past experience, episode, story, instruction, or other semantic content, which can be processed by a natural language processing technique.

The term “visual information” refers to digital data representing visual content, including still image data, moving-image data, or other pixel-based data, associated with a user's past experience or with a narrative generated by a model.

The term “natural language processing technique” refers to a computational technique for analyzing and processing language data, including tokenization, part-of-speech tagging, syntactic parsing, semantic analysis, named entity recognition, text classification, or related operations on text.

The term “image analysis technique” refers to a computational technique for processing and interpreting visual information, including image resizing, color space conversion, feature extraction, object detection, face detection, segmentation, or related operations on image data.

The term “semantic information” refers to structured or semi-structured data describing meanings extracted from description information, including entities, relationships, locations, events, topics, temporal information, or other conceptual elements.

The term “emotional information” refers to data representing an emotional state inferred from description information or visual information, such as degrees or categories of joy, sadness, fear, anger, surprise, nostalgia, or other affective states.

The term “instruction sentence” refers to text data provided by a user that expresses a requirement, constraint, preference, or style for content generation, and that is used as part of a prompt sentence for a generative artificial intelligence model.

The term “prompt sentence” refers to a text sequence constructed by the system and input to a generative artificial intelligence model so as to instruct the model to perform a specific generation task, such as generating a narrative text or generating visual content.

The term “generative artificial intelligence model” refers to a computational model trained to generate new data, including a text model that generates natural language text, an image model that generates images, or a video model that generates sequences of images, based on input data such as a prompt sentence.

The term “narrative text” refers to text generated by a generative artificial intelligence model that represents a story, sequence of events, or descriptive content that can be segmented into one or more scene pieces.

The term “scene piece” refers to a portion of a narrative text that represents a coherent unit of time, location, and action, and that can be used as a basic unit for generating corresponding visual content.

The term “structured data” refers to data in which elements of a scene piece are explicitly represented, including at least an appearing entity, a background environment, a temporal structure, and an emotional tendency, in a form that is machine-readable.

The term “appearing entity” refers to an object, character, or other identifiable element that is specified as present within a scene piece of a narrative text or within corresponding visual content.

The term “background environment” refers to contextual information describing the setting of a scene piece, including a location, scenery, or environmental conditions that form the backdrop for appearing entities.

The term “temporal structure” refers to information describing time-related aspects of a narrative or scene piece, including ordering, duration, temporal relationships, or transitions between events.

The term “emotional tendency” refers to an attribute associated with a scene piece that indicates a dominant or characteristic emotional quality, such as joyful, sad, tense, calm, or nostalgic.

The term “image generative artificial intelligence model” refers to a generative artificial intelligence model that receives a prompt, optionally together with auxiliary data, and outputs one or more still visual contents or short-time visual contents.

The term “still visual content” refers to a single image frame or static visual representation generated by an image generative artificial intelligence model for a particular scene piece.

The term “short-time visual content” refers to a short sequence of image frames or a short clip representing motion or change over a limited time interval, generated for a particular scene piece.

The term “moving-image editing program” refers to a software component configured to arrange still visual contents or short-time visual contents in a time direction, to apply transitions and effects, and to render them into moving-image content.

The term “moving-image content” refers to a data stream or file comprising a time-ordered sequence of image frames, optionally with audio information, having a predetermined resolution and frame rate, and representing animation or video.

The term “color tone” refers to visual parameters such as hue, saturation, contrast, or color grading that are applied to moving-image content to modify its visual impression.

The term “screen effect” refers to a visual effect applied to image frames, such as blur, vignette, glow, motion effect, or other digital processing that alters the appearance of the frames.

The term “audio information” refers to sound data associated with moving-image content, including background music, sound effects, and other audio tracks.

The term “storage device” refers to a computer-readable medium or storage subsystem, such as a magnetic storage device, optical storage device, semiconductor memory, or network-based storage, configured to store moving-image content and related metadata.

The term “metadata” refers to auxiliary data associated with moving-image content, including identifiers, timestamps, user identifiers, emotional information, prompt information, or other descriptive data used for indexing, retrieval, or processing.

The term “access identifier” refers to data, such as a uniform resource identifier, token, or key, that uniquely identifies moving-image content stored in a storage device and allows an information processing terminal to request access to the content.

The term “facial expression information” refers to data representing a user's facial state, derived from image data or sensor data, and used to estimate an emotional state of the user.

The term “audio information of the user” refers to sound data, such as speech or non-speech vocalizations, captured from the user and used to estimate an emotional state.

The term “emotion analysis model” refers to a computational model configured to receive at least one of facial expression information, audio information, description information, or visual information, and to output an estimate of an emotional state.

The term “current emotional state” refers to an emotional condition of the user estimated at or near real time, based on data received during playback of moving-image content or within a virtual-reality environment.

The term “playback parameters” refers to technical settings that influence how moving-image content is rendered or output, including playback speed, volume level, dynamic range of audio, or selection of alternative audio or visual tracks.

The term “three-dimensional virtual space” refers to a computer-generated spatial representation in which objects have three-dimensional coordinates and can be rendered from different viewpoints.

The term “virtual-reality environment” refers to a rendered form of a three-dimensional virtual space that is displayed to a user via a head-mounted display or similar device, and that may respond to movements of the user.

The term “visual display engine” refers to a software component configured to render images of a three-dimensional virtual space, apply lighting and shading, and generate frames for display in a two-dimensional or virtual-reality format.

The term “head-mounted display” refers to a display device worn on a user's head that presents visual content, including virtual-reality content, to the user's eyes, and may include sensors for tracking head movements.

The term “camera viewpoint” refers to a virtual camera position and orientation used by a visual display engine to render images from a particular perspective within a three-dimensional virtual space.

The term “gaze direction” refers to a direction associated with the user's line of sight, estimated from head orientation, eye tracking, or other sensor data, and used to control a camera viewpoint or other rendering parameters.

The term “position information” refers to spatial coordinates or related data representing the location of a user or a device within a real environment or within a three-dimensional virtual space.

The term “lighting condition” refers to parameters of simulated illumination within a three-dimensional virtual space, including light intensity, color, direction, and distribution.

The term “acoustic condition” refers to parameters of simulated or rendered sound within a virtual environment, including volume, reverberation, spatialization, and relative balance of audio sources.

The term “immersive and interactive visual experience” refers to a state in which a user perceives a high degree of presence and engagement with visual content, due to dynamic adaptation of camera viewpoint, lighting, audio, and other parameters in response to user behavior and emotional state.

In one embodiment, a server cooperates with one or more terminals operated by a user to implement the claimed system. The server comprises at least one processor, a main memory, a non-volatile storage device, and a communication interface connected to a communication network. The terminal comprises at least one processor, a display, an input device such as a touch panel, a camera, a microphone, a local storage, and a communication interface. The user operates the terminal to provide description information and visual information and to view moving-image content and virtual-reality content.

The server executes a plurality of software modules stored in the non-volatile storage device, including a web service module, a natural language processing module, an image analysis module, a prompt construction module, a first generative AI model interface, an image generative AI model interface, a moving-image editing module, an emotion analysis module, a virtual-reality rendering interface, and a metadata management module. The server may implement these modules in an execution environment such as a general-purpose operating system and a runtime environment for a high-level programming language.

The terminal executes a client application that provides a user interface for inputting description information, selecting image files, previewing generated content, and capturing facial expression information and audio information. The terminal may additionally execute a lightweight emotion estimation module or may transmit captured sensor data to the server for centralized emotion analysis. The terminal may be implemented as a smartphone, a tablet device, a head-mounted display unit, or a personal computer.

The server uses the natural language processing module to analyze description information. In one example, the server uses a transformer-based language model implemented in a machine learning framework to perform tokenization, part-of-speech tagging, and named entity recognition. The language model may have an encoder with multiple self-attention layers, each self-attention layer including multi-head attention computations and feedforward sub-layers with residual connections and layer normalization. The server supplies tokenized text to such an encoder and extracts internal representations at each token position, resulting in a feature tensor that encodes semantic relationships between words and sentences.

The server uses these internal representations to derive semantic information such as a list of entities (characters, locations, objects), temporal expressions, and action phrases. The server stores this semantic information in a structured data record. The server also applies a classification head on top of the encoder outputs to compute emotional information. The classification head may be a fully connected neural network that computes a probability distribution over emotion categories (for example, joy, sadness, surprise, fear, anger, calm, nostalgia). The server uses a softmax output layer and a cross-entropy loss function during training of this classification head. During inference, the server uses the resulting probabilities as emotional information associated with the description information.

The server uses the image analysis module to process visual information. The server uses an image processing library to decode images in formats such as JPEG and PNG into in-memory arrays. The server resizes images to a standard resolution, converts color space, and normalizes pixel values. The server applies a convolutional neural network for image feature extraction and for detection of objects or faces. The convolutional neural network may include multiple convolutional layers, pooling layers, and activation functions such as rectified linear units. When faces are detected, the server crops regions of interest and applies another neural network trained for facial emotion classification to derive additional emotional information. The server fuses emotional information derived from text and visual information by computing a weighted sum or concatenating emotion vectors followed by a small neural network that outputs a unified emotion representation.

The server uses the prompt construction module to build a prompt sentence for a first generative AI model that generates narrative text. The server collects semantic information (entities, locations, temporal clues), unified emotional information, and optionally an instruction sentence entered by the user. The server combines these elements into a grammatically coherent prompt sentence using predetermined templates and rule-based phrase ordering. The server may apply non-trivial rules, such as inserting explicit scene count constraints or style modifiers when particular emotions dominate. For example, when joy and excitement are dominant, the server inserts phrasings such as “emphasizing laughter and dynamic scenes” and when nostalgia is dominant, the server inserts phrases such as “highlighting warm and reflective moments.”

In one concrete example, the user supplies the following description information: “I spent a fun day at the beach with my friends before graduation.” The server detects entities such as “friends” and “beach,” temporal context such as “before graduation,” and emotional information indicating joy and nostalgia. The user may further input an instruction sentence, such as “Please create the story in three scenes suitable for animation.” The server constructs the following prompt sentence:
“The user has described a joyful and nostalgic day at the beach with friends before graduation and has provided photos taken at the seaside. Based on this, please generate a detailed story in three scenes that emphasizes friendship, laughter, games on the sand, and a beautiful sunset, suitable as a script for an animation.”

In another example, the user supplies an instruction sentence only, such as:
“Please create a story in a medieval fantasy world where a young knight fights a dragon to protect his village.”

The server uses this instruction sentence together with any inferred emotion (for example, excitement) as a prompt sentence for the first generative AI model without additional description information.

The server uses the first generative AI model interface to call a generative AI model that generates narrative text. In one embodiment, the server uses a large-scale transformer-based language model with multiple decoder layers configured for text generation. The server provides the prompt sentence as input tokens, sets generation parameters such as a maximum token length, a temperature parameter for sampling diversity, and a nucleus sampling threshold, and obtains generated narrative text. The model internally computes next-token probabilities using self-attention across the prompt and previously generated tokens. The server receives the narrative text and stores it as narrative text data.

The server applies the natural language processing module again to the narrative text to derive scene pieces and structured data. The server identifies segmentation points for scene pieces using a combination of rule-based heuristics (for example, paragraph breaks and discourse markers such as “later,” “after that,” and “finally”) and learned sequence labeling models. The server maps each scene piece to structured data including appearing entities, background environment descriptors, temporal structure elements, and an emotional tendency. For example, the server may use clustering over sentence-level emotion scores to determine a dominant emotional tendency for each scene piece. The server stores this structured data in a scene table associated with the narrative text.

The server uses the image generative AI model interface to generate visual content for each scene piece. The server constructs a further prompt sentence for an image generative AI model by combining the scene description, the background environment, the emotional tendency, and references to any user-provided images. For example, for a first scene of the beach story, the server may construct the prompt sentence:
“Generate a bright and joyful animation-style image of several friends playing on a sunny beach before graduation, using the attached beach photo as a style and composition reference, with vivid colors and a clear blue sky.”

The server provides the prompt sentence and, when supported, the pre-processed visual information as inputs to an image generative AI model. The image generative AI model may be implemented as a diffusion model with a U-shaped network architecture. The server encodes the prompt sentence using a text encoder and injects the resulting text embeddings into the diffusion model via cross-attention layers. The server configures diffusion steps, noise schedule parameters, and guidance scales. The model performs iterative denoising, using the U-shaped network and attention layers to progressively transform random noise into a still visual content consistent with the prompt sentence. The server repeats this process for each scene piece to obtain multiple still visual contents or short-time visual contents. The server stores these contents as image files or short video segments.

The server uses the moving-image editing module to assemble still visual contents and short-time visual contents into moving-image content. The server arranges the contents on a timeline data structure, assigning start and end times for each scene piece based on narrative pacing criteria. The server uses a moving-image processing engine, such as a non-linear editing engine, to composite images, apply transitions, and insert titles. The server also selects audio information including background music and sound effects based on emotional information. For example, when the emotional tendency for a scene piece is joyful, the server chooses a high-tempo, major-key track from an audio library. The server adjusts color tone and screen effects by applying operations such as color grading, vignette, and motion blur.

The server then renders the timeline into an encoded moving-image file at a predetermined resolution and frame rate, such as 1920×1080 pixels at 30 frames per second. The server stores the resulting moving-image content and metadata describing the generation process.

The server uses the metadata management module to assign an access identifier to each generated moving-image content. The metadata includes user identifiers, timestamps, the prompt sentences used, the emotional information, and links to underlying scene data. The server stores this metadata in a database to enable efficient retrieval, updating, and audit of generated content. This structured metadata architecture improves data management by enabling query-based access to specific content by emotion, scene composition, or user-defined criteria.

The server uses the emotion analysis module to process real-time facial expression information and audio information of the user during playback. The terminal captures images from the camera and audio from the microphone while the moving-image content is being played. The terminal transmits sampled frames and audio segments to the server. The server applies an image feature extractor and a recurrent or temporal convolutional network trained on labeled emotional sequences to estimate a current emotional state. For audio analysis, the server computes features such as Mel-frequency cepstral coefficients, energy, and pitch contours, and applies a neural network classifier trained with a loss function such as cross-entropy or focal loss. The server fuses visual and audio emotion predictions using a learned fusion layer that outputs a probability distribution over current emotional states.

The server uses this current emotional state to control rendering parameters. When the server determines that the user exhibits increased joy while watching a scene, the server adjusts playback parameters to increase brightness, contrast, and volume of certain audio bands. When the server determines a calmer or sadder state, the server reduces brightness and switches to more subdued sound tracks when alternative tracks are available. In a streaming configuration, the server modifies encoded video parameters or sends control commands to the terminal to adjust local rendering, such as applying color filters or switching between different audio mixes. This dynamic control based on emotional feedback provides a technical improvement in responsiveness and personalization of rendered content beyond static pre-authored video.

The server can also generate and manage virtual-reality content. The server uses the structured data for scene pieces to construct a three-dimensional virtual space using a rendering engine. The server instantiates background objects and character objects from asset libraries and places them at coordinates defined by the scene data. The server sets up physically based lighting and defines shaders for materials. The server configures a camera system that supports six degrees of freedom movement. The server exports or streams a virtual-reality environment to a head-mounted display connected to the terminal.

The terminal executes a virtual-reality viewer that communicates head pose and optionally gaze direction to the server or to a local rendering engine. The server uses gaze direction and position information to adjust the camera viewpoint, so that the user can look around the virtual scene naturally. The server further adjusts lighting conditions and acoustic conditions according to the current emotional state. For example, when the user shows fear or tension in a dragon battle scene, the server may darken peripheral lighting and intensify low-frequency audio components. This technical configuration achieves a tight coupling between emotion analysis, three-dimensional rendering, and playback control, improving immersion and interactivity.

The described system provides technical advantages that go beyond mere automation of human creative tasks. The server uses intermediate structured data and prompt constructions as internal technical mechanisms for controlling multiple generative AI models and editing engines. By explicitly extracting scene-level data and emotional information and by using these as control signals for prompt sentences and rendering parameters, the server reduces inconsistencies between narrative text and visual content, decreases the need for manual correction, and optimizes the number of calls to external generative AI services. The explicit scene segmentation and structured data representation enable parallel processing of scene pieces on multiple processing units, thereby improving throughput and reducing end-to-end generation time.

The neural network architectures used in the natural language processing module, the image analysis module, the emotion analysis module, and the generative AI models are trained with large datasets and optimized with gradient-based learning methods. During training, the server uses loss functions such as cross-entropy loss for classification tasks and reconstruction or perceptual losses for generative tasks. The server updates model parameters with stochastic gradient descent or adaptive optimization algorithms. The server may apply data augmentation techniques, such as random cropping and color jittering for images and synonym replacement or back-translation for text, to improve generalization. These training choices contribute to improved accuracy of semantic extraction, emotion estimation, and content generation, which in turn support the technical functions of the system.

The system diverges from conventional rule-based automation by combining learned models with explicitly designed control rules for prompt construction and scene assembly. The server employs non-standard processing flows such as building multi-stage prompt sentences, mapping emotional vectors to visual parameter spaces via learned and hand-crafted mappings, and controlling multiple heterogeneous software engines (generative text model, image model, editing engine, and rendering engine) through a shared structured representation. This architecture improves computational efficiency by reusing intermediate representations, reduces memory footprint by avoiding redundant decoding of large models for each frame, and reduces communication load by transmitting compact access identifiers and control parameters instead of large raw data between the server and terminals.

In alternative embodiments, the server may execute some or all of the generative AI models locally or may call remote model services via network APIs. The server may use different model architectures, such as recurrent neural networks for narrative generation or generative adversarial networks for image generation, provided that the server still constructs and supplies prompt sentences and structured data as described. The terminal may perform more processing locally, such as executing part of the emotion analysis module on-device to reduce network latency and to protect user privacy, while still sending summary emotional information to the server for rendering control.

Through these embodiments, the server, the terminal, and the user cooperate to implement the claimed system in a manner that can be realized using known hardware and software components. The disclosed modular structure, internal data formats, neural network designs, and cross-module control flows allow a person skilled in the art to practice the invention and to adapt it to various platform configurations while maintaining the technical advantages in consistency, performance, and emotion-aware adaptability of generated moving-image and virtual-reality content.

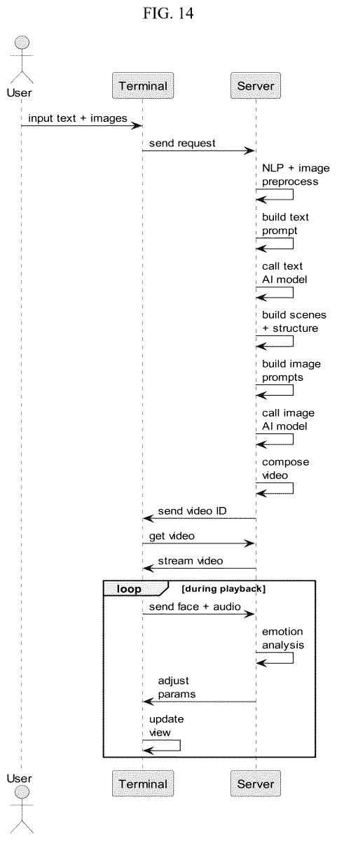

The following describes the processing flow using FIG. 14.

### Step 1

The user operates the terminal to input description information and select visual information.

The terminal displays an input screen including a text field and an image selection control. The user types description information such as an episode, an instruction, or a story seed (for example, “I spent a fun day at the beach with my friends before graduation.”). The user also selects one or more images from local storage using a gallery or file picker.

Input: user keystrokes and image selection operations.

Processing: the terminal converts the typed characters into a text string encoded in UTF-8 and obtains file paths or binary data for the selected images. The terminal attaches user identification data and a timestamp to form a request record.

Output: a structured request payload containing the description text, image data, user identifier, and timestamp held in the memory of the terminal.

### Step 2

The terminal transmits the request payload to the server.

The terminal packages the description text and image data into a structured format, such as a JSON object with fields {“text”, “images”, “userId”, “timestamp”} and a multipart body for binary image data. The terminal establishes a secure network connection and sends the payload to a predefined server endpoint.

Input: the structured request payload in the memory of the terminal.

Processing: the terminal serializes the JSON object, encodes the image data (for example, as base64 or as multipart form-data), and encapsulates the serialized bytes into an HTTPS request. The terminal uses its communication interface to send the request over a communication network.

Output: an HTTPS request containing the user's description information and visual information delivered to the server.

### Step 3

The server receives and validates the request payload.

The server accepts the HTTPS request at a network interface and passes it to a web service module. The server parses the JSON body and the attached image data and checks that required fields are present.

Input: the HTTPS request containing serialized JSON and image data. Processing: the server decodes the JSON into internal objects, checks for non-empty text and at least one valid image, and verifies the user identifier format. The server writes the raw text and raw images to temporary storage and creates a job record with a unique job identifier.

Output: a validated job entry stored in server memory and storage, including references to raw description text, raw image files, and a job identifier.

### Step 4

The server preprocesses the visual information using an image analysis module.

The server loads each raw image associated with the job from temporary storage into memory. The server standardizes the visual information for downstream processing.

Input: raw image files referenced by the job record.

Processing: the server decodes each image into an array of pixel values, resizes the array to a standard resolution (for example, 512 ×512 pixels), converts color space to a standard format (for example, RGB), and normalizes pixel values to a fixed numeric range. The server may run a convolutional neural network for object or face detection and crop regions of interest.

Output: preprocessed image tensors and optional face or object regions, stored in memory and linked to the job record.

### Step 5

The server analyzes the description information using a natural language processing module. The server loads the user's description text from storage and feeds it into a transformer-based language model.

Input: the UTF-8 encoded description text.

Processing: the server tokenizes the text into subword units, maps tokens to embeddings, and passes them through multiple self-attention layers. The server computes contextual representations for each token and aggregates these representations to identify semantic elements such as entities (for example, “friends,” “beach”), locations, temporal phrases, and action phrases. The server also applies a classification head to the contextual representations to compute a probability distribution over emotion categories.

Output: semantic information (a list of entities, locations, events, and temporal markers) and emotional information (an emotion probability vector) associated with the description text.

### Step 6

The server refines emotional information by combining text-based and image-based analysis.

The server uses outputs from the natural language processing module and from image-based emotion classifiers.

Input: the text-derived emotion vector and any image-derived emotion vectors from facial expression analysis.

Processing: the server fuses emotion vectors by computing a weighted average or feeding concatenated vectors into a small fully connected neural network that outputs a unified emotion vector. The server normalizes this unified emotion vector so that its components sum to one.

Output: a unified emotional information record representing the user's overall emotional state associated with the past experience.

### Step 7

The server constructs a prompt sentence for a first generative AI model based on semantic and emotional information.

The server uses a prompt construction module that receives semantic information, unified emotional information, and any instruction sentence input by the user.

Input: semantic information (entities, locations, temporal data), unified emotional information, and an optional user instruction sentence.

Processing: the server fills a text template with these elements, applying rule-based phrase insertion. For example, if joy and nostalgia dominate, the server inserts phrases such as “joyful and nostalgic” and “highlighting warm memories.” The server ensures that the prompt sentence requests a specific number of scenes, a style suitable for animation, or other constraints.

Output: a complete textual prompt sentence ready for input to the first generative AI model.

### Step 8

The server generates narrative text using the first generative AI model.

The server sends the prompt sentence to a transformer-based generative AI model via the first generative AI model interface.

Input: the constructed prompt sentence.

Processing: the server encodes the prompt sentence into tokens, passes them to a decoder model configured for autoregressive generation, and sets parameters such as maximum length, temperature, and nucleus sampling threshold. The model computes next-token probabilities at each generation step using attention over previous tokens and selects tokens according to the configured sampling strategy until an end condition is met.

Output: a narrative text representing a complete story or script that extends the user's description in multiple scenes.

### Step 9

The server segments the narrative text into scene pieces and creates structured data.

The server applies the natural language processing module once more to the generated narrative text to identify scene boundaries and per-scene attributes.

Input: the narrative text generated by the first generative AI model.

Processing: the server parses the text into sentences, analyzes discourse markers and paragraph boundaries, and applies a scene segmentation model to assign each sentence to a scene index. The server derives, for each scene, appearing entities, background environment descriptors, temporal relations, and an emotional tendency based on per-sentence emotion scores. The server creates a structured data object for each scene piece and stores all such objects in a scene list.

Output: a scene list consisting of multiple structured data records, each record including an appearing entity set, background environment description, temporal structure, and emotional tendency.

### Step 10

The server constructs prompt sentences for an image generative AI model for each scene piece.

The server uses the scene list and the preprocessed visual information to generate prompt sentences for visual generation.

Input: structured scene data (entities, background, emotional tendency) and preprocessed images.

Processing: for each scene, the server builds a descriptive prompt sentence that specifies the visual style, context, and emotional tone. If user images are available, the server adds phrases that instruct the model to use the images as references. The server may also include instructions regarding camera perspective or composition.

Output: a set of prompt sentences, each associated with a particular scene piece and linked to corresponding preprocessed image data.

### Step 11

The server generates still visual contents or short-time visual contents using an image generative AI model.

The server passes each visual prompt sentence and associated image data to an image generative AI model.

Input: a visual prompt sentence and, optionally, reference image tensors.

Processing: the server encodes the prompt sentence using a text encoder and injects the resulting embeddings into a diffusion or generative adversarial framework. The model performs iterative operations, such as denoising steps in a diffusion model, guided by the text embeddings and any image features. The server configures the number of iterations, the guidance scale, and resolution parameters. The model outputs an image frame or a short sequence of frames for each scene.

Output: still visual contents or short-time visual contents corresponding to the scene pieces, stored as image files or short video clips.

### Step 12:

The server composes moving-image content using a moving-image editing module.

The server uses the set of generated visual contents and the scene list to produce a unified animation.

Input: still visual contents and short-time visual contents for all scene pieces, and associated structured scene data.

Processing: the server creates a timeline structure where each track holds visual clips for a scene. The server assigns durations to each clip according to narrative pacing rules and emotional tendencies. The server applies transitions between clips, adjusts color tone based on emotional tendency, and selects and synchronizes audio information such as background music and sound effects. The server then encodes the composed timeline into a moving-image file at a predefined resolution and frame rate.

Output: a completed moving-image content file representing visually attractive animation or virtual-reality visual content.

### Step 13

The server stores the moving-image content and metadata and provides an access identifier to the terminal.

The server registers the generated content in a storage subsystem.

Input: the moving-image content file and its associated generation data (prompt sentences, scene data, emotional information).

Processing: the server writes the moving-image content file to a storage device, creates metadata entries including user identifier, job identifier, timestamps, and prompt history, and generates a unique access identifier or URL for the content. The server updates its database with links between the access identifier and the stored file. The server sends the access identifier to the terminal.

Output: a stored moving-image content and a corresponding access identifier delivered to the terminal.

### Step 14:

The terminal retrieves and plays back the moving-image content.

The terminal receives the access identifier and uses it to request the content from the server. Input: the access identifier provided by the server.

Processing: the terminal sends a content request using the access identifier; the server responds with a stream or file. The terminal receives the stream or file, decodes the video and audio data using its media playback components, and renders the moving-image content on the display and speakers.

Output: rendered frames and audio outputs presented to the user on the terminal.

### Step 15

The terminal captures facial expression information and audio information of the user during playback and transmits them to the server.

While the moving-image content is playing, the terminal samples sensor data.

Input: camera frames and microphone audio captured during playback.

Processing: the terminal acquires frames at a specified rate, encodes them into compressed images or video snippets, and captures audio segments. The terminal associates timestamps with each sample and packages the data into an emotion monitoring request. The terminal sends this request to the server over the network.

Output: a data stream containing time-stamped facial expression information and audio information delivered to the server.

### Step 16

The server estimates a current emotional state of the user from the captured data.

The server receives the emotion monitoring data and processes it using the emotion analysis module.

Input: time-stamped facial images and audio segments from the terminal. P

rocessing: the server detects faces in the images, extracts facial landmarks, and computes feature vectors for each frame using a convolutional or recurrent neural network trained for emotion recognition. For audio, the server computes spectral and temporal features and feeds them to a neural classifier. The server fuses visual and audio outputs through a fusion network to obtain a probability distribution over emotional states. The server selects the highest-probability emotion as the current emotional state and may maintain a smoothed estimate over a time window.

Output: a current emotional state label and associated confidence values maintained for the ongoing playback session.

### Step 17

The server dynamically adjusts rendering parameters of the moving-image content based on the current emotional state.

The server uses the estimated current emotional state as control input.

Input: the current emotional state and identifiers for the moving-image content currently being played.

Processing: the server maps the emotional state to specific adjustment commands, such as “increase brightness and saturation,” “reduce brightness and enhance blue tones,” or “switch to calm audio track.” In a streaming scenario, the server modifies video encoding parameters or injects metadata that instructs the terminal to change local rendering filters. In a downloaded playback scenario, the server returns control messages to the terminal specifying new playback parameters.

Output: adjusted control information that changes at least one of color tone, brightness, acoustic characteristics, or playback parameters for the moving-image content during playback.

### Step 18

The terminal applies the received control information to modify playback in real time.

The terminal receives control messages or metadata updates from the server. Input: playback adjustment commands corresponding to the user's current emotional state. Processing: the terminal updates the video rendering pipeline by changing shader parameters, applying color filters, or modifying brightness and contrast. The terminal switches or mixes audio tracks or alters volume levels for certain frequency ranges. These changes are applied to subsequent frames and audio samples without interrupting playback.

Output: a dynamically adapted moving-image presentation whose visual and acoustic characteristics are aligned with the user's current emotional state.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

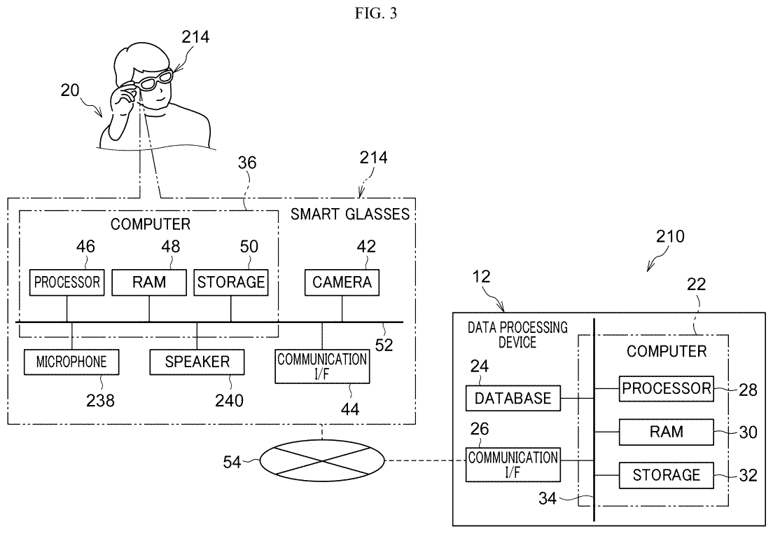

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

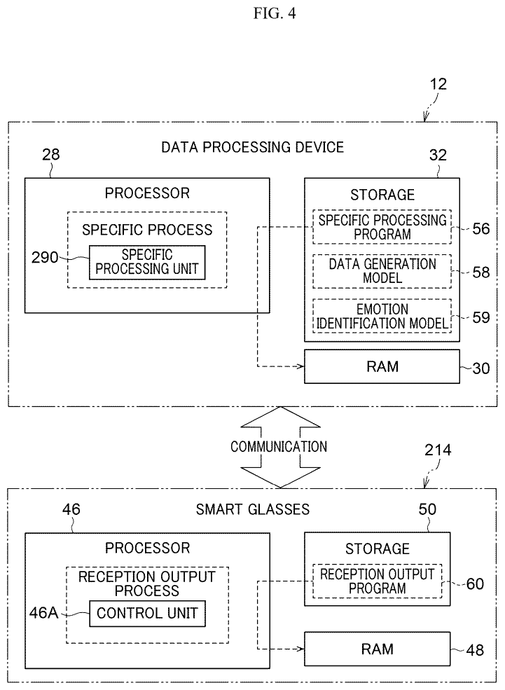

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

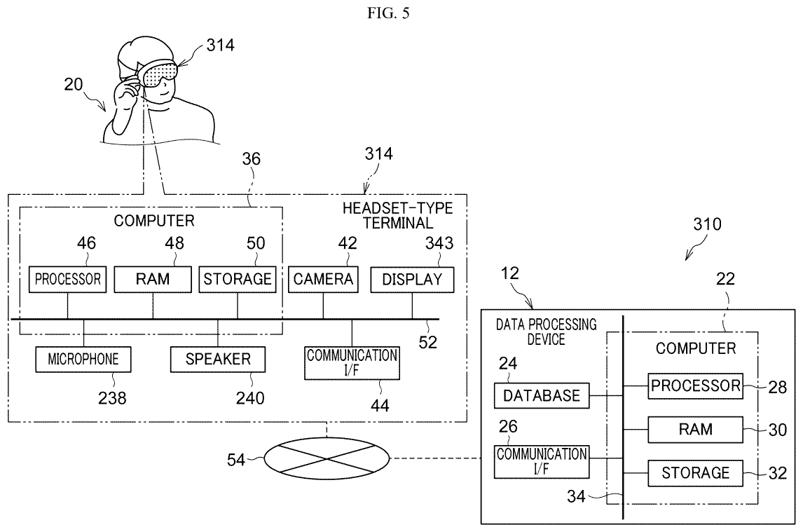

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

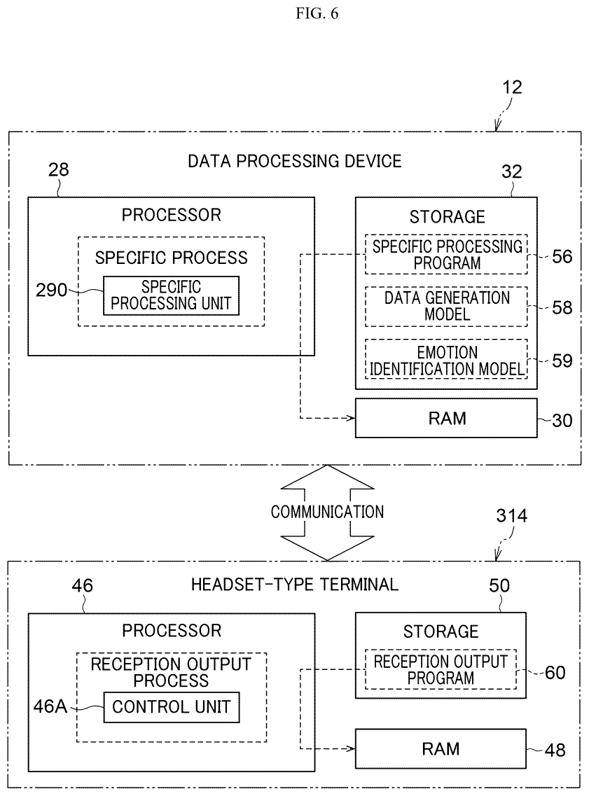

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

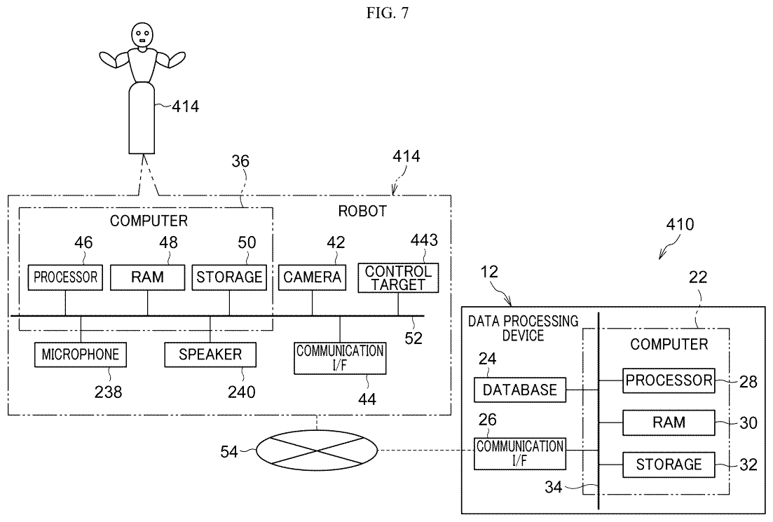

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

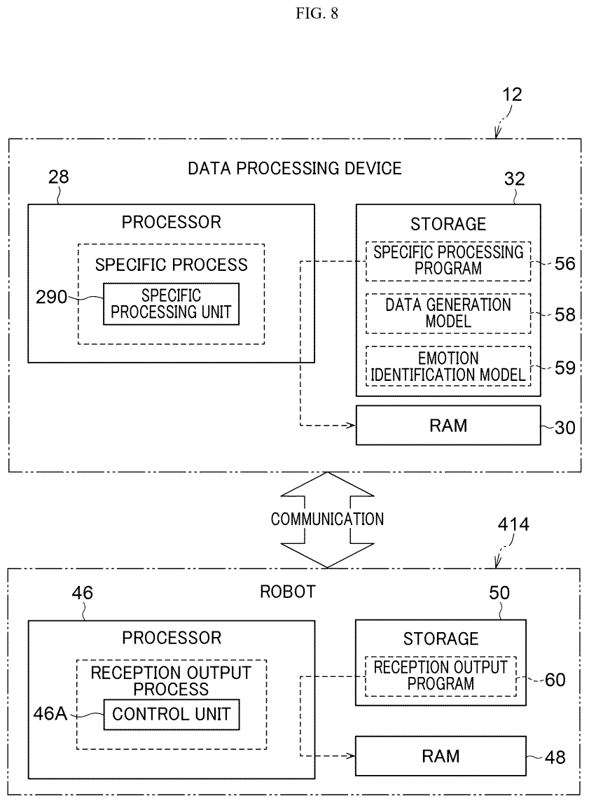

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2 E

xplanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

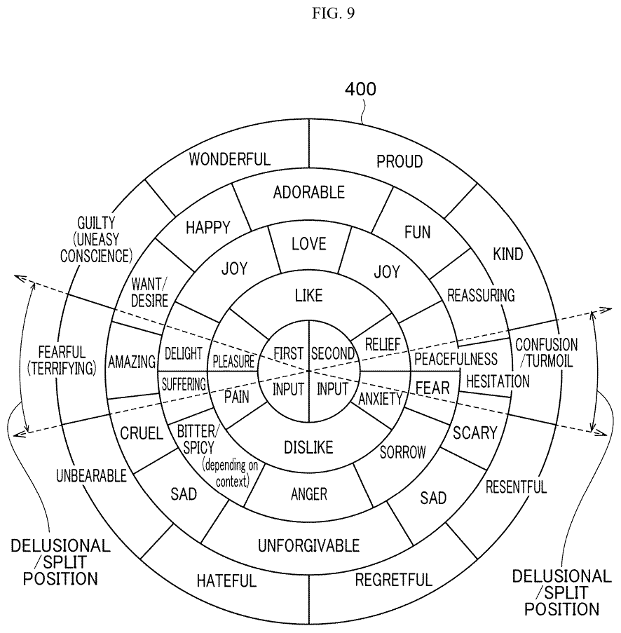

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

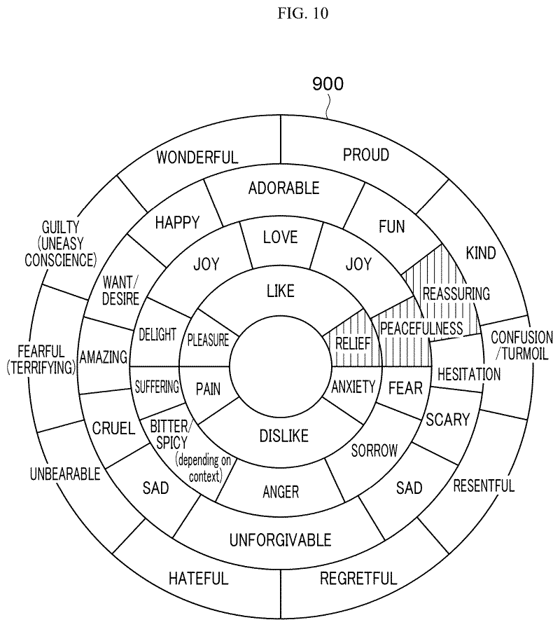

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to receive, from a terminal operated by a user, descriptive information of a past event and imaging information related to the past event, and store the descriptive information and the imaging information in a storage unit,
analyze the descriptive information by using an external or internal natural language processing function to extract event summary information, subject information, time information, location information, and emotion information,
analyze the imaging information by using an external or internal image analysis function to extract subject-matter information, scene information, object information, and facial expression information,
generate an integrated representation of the past event based on the event summary information, the subject information, the time information, the location information, the emotion information, the subject-matter information, the scene information, the object information, and the facial expression information, and construct a prompt sentence including the integrated representation,
input the prompt sentence into a generative AI model and cause the generative AI model to generate new content based on the integrated representation, and
obtain the new content output from the generative AI model and provide the new content to the terminal.

### (Supplementary 2)

The system according to supplementary 1,
wherein the processor is configured to
generate, for character information included in the new content output from the generative AI model, an additional prompt sentence in response to an instruction to change at least one of length, writing style, and description target, re-input the additional prompt sentence into the generative AI model, and control the generative AI model to generate a revised version of the new content.

### (Supplementary 3)

The system according to supplementary 1,
wherein the processor is configured to
communicate, via a communication network, with a portable information processing device as the terminal, the portable information processing device being configured to display an input screen for the descriptive information of the past event and the imaging information, and to display a screen for presenting the new content to the user.

### Application Example 1

### (Supplementary 1)

A system comprising a processor,
wherein the processor is configured to
acquire, by an information processing apparatus, language information describing a past experience from a user and image information related to the experience as input information, and analyze a psychological state of the user based on the input information,
construct a prompt sentence for instructing a generative AI model to generate story information, the prompt sentence being constructed based on the analyzed psychological state and the language information, and input the prompt sentence to the generative AI model to obtain the story information,
generate narration audio information by performing speech synthesis processing based on the story information,
generate motion image information by using a video editing program based on the image information and the narration audio information,
generate personalized motion image information by adding visual effects and background sound corresponding to atmosphere information and sound information selected by the user to the motion image information, and
store the personalized motion image information in a storage device and make the personalized motion image information available to the user via a communication network.

### (Supplementary 2)

The system according to supplementary 1,
wherein the processor is configured to perform processing in the video editing program such that the motion image information is generated by arranging, on a time axis, a plurality of still images included in the image information according to a predetermined time allocation and screen transition effect, and sequentially displaying the still images in synchronization with a playback time of the narration audio information.

### (Supplementary 3)

### The System According to Supplementary 1,

wherein at least a part of the information processing apparatus operates on a portable information terminal, and the processor is configured to cause the portable information terminal to perform acquisition of the language information and the image information, selection of the atmosphere information and the sound information, and reception of operations for playback and sharing of the personalized motion image information via a user interface including a display screen and an input screen.

### Example 2

### (Supplementary 1)

A system comprising a processor,
wherein the processor is configured to
receive, from a terminal connected to an information processing apparatus, character information concerning a past event input by a user and visual information related to the past event,
apply language processing technology to the character information to extract scene elements, action elements, time elements, place elements, and emotion elements concerning the past event, apply image processing technology to the visual information to extract subject categories, numbers of subjects, environment categories, and color tendencies, and generate scene representation data obtained by integrating the extracted elements,
automatically generate a prompt sentence, used as an input sentence for a generative AI model, on the basis of the scene representation data, the prompt sentence including at least a position element, a time element, an action element, and an emotion element,
execute an image generation process or a video generation process using the generative AI model, by using the prompt sentence and the visual information as inputs, and generate a visual expression corresponding to the prompt sentence,
provide the visual expression to the terminal and receive, from the terminal, evaluation information or correction request information from the user regarding the visual expression, apply language processing technology to the evaluation information or the correction request information to extract change instructions concerning at least one of a time element, a color element, a subject element, and an action element, update the scene representation data and the prompt sentence based on the change instructions, and operate the generative AI model again on the basis of an updated prompt sentence to regenerate the visual expression.

### (Supplementary 2)

The system according to supplementary 1,
wherein the processor is configured to
generate, as the visual expression, a plurality of time-series images, and create an animation as a moving image by sequentially displaying the plurality of time-series images using the generative AI model in the video generation process.

### (Supplementary 3)

The system according to supplementary 1,
wherein the processor is configured to
cooperate with a portable information terminal as the terminal, and, through a display control function and an input control function operating on the portable information terminal, perform transmission and reception of the character information, the visual information, the evaluation information, and the correction request information, and present the visual expression and a regenerated result of the visual expression on the portable information terminal.

### Application Example 2

### (Supplementary 1)

A system comprising a processor,
wherein the processor is configured to
receive, from an information processing terminal operated by a user, description information representing a past experience of the user and visual information associated with the past experience, as input data,
analyze the description information and the visual information by using a natural language processing technique and an image analysis technique to extract semantic information and emotional information, and construct, based on the semantic information and the emotional information, a prompt sentence for causing a generative artificial intelligence model to generate a narrative text,
input the prompt sentence to the generative artificial intelligence model to cause the generative artificial intelligence model to generate the narrative text, re-analyze the generated narrative text by using the natural language processing technique to divide the narrative text into a plurality of scene pieces, and generate structured data for each scene piece, the structured data including at least an appearing entity, a background environment, a temporal structure, and an emotional tendency,
generate, based on the structured data and the visual information, a prompt sentence for an image generative artificial intelligence model, and cause the image generative artificial intelligence model to generate, for each scene piece, a still visual content or a short-time visual content,
arrange the still visual contents or the short-time visual contents in a time direction, use a moving-image editing program to automatically construct moving-image content having a predetermined resolution and a predetermined frame rate, and apply, to the moving-image content, color tones, screen effects, and audio information corresponding to the emotional information, thereby outputting the moving-image content as visually attractive animation or virtual-reality visual content,
store the moving-image content in a storage device together with related information, generate an access identifier corresponding to the moving-image content, and provide the access identifier to the information processing terminal, and
during playback of the moving-image content, receive, as additional input data, facial expression information or audio information of the user transmitted from the information processing terminal, estimate a current emotional state of the user by using an emotion analysis model, and dynamically adjust at least one of color tone, brightness, acoustic characteristics, and playback parameters of the moving-image content according to the current emotional state.

### (Supplementary 2)

The system according to supplementary 1,
wherein the processor is configured to, when generating the prompt sentence to be input to the generative artificial intelligence model, acquire an instruction sentence input by the user via the information processing terminal in addition to the semantic information and the emotional information, generate an extended prompt sentence including the instruction sentence, and input the extended prompt sentence to the generative artificial intelligence model so as to control a scene configuration and an expression style of the narrative text in accordance with an intention of the user.

### (Supplementary 3)

The system according to supplementary 1,
wherein the processor is configured to, as the moving-image content, construct a three-dimensional virtual space in which background objects and character objects corresponding to the structured data are arranged, generate a virtual-reality environment for a head-mounted display by using a visual display engine, control a camera viewpoint in the virtual-reality environment in accordance with at least one of a gaze direction and position information of the user, and change at least one of a lighting condition and an acoustic condition in the virtual-reality environment according to the current emotional state, thereby providing an immersive and interactive visual experience.

What is claimed is:

1. A system comprising:
circuitry configured to:
receive, via a communication interface coupled to a packet-switched network, descriptive information and imaging information associated with a past event from a terminal device operated by a user;
analyze the descriptive information using a natural language processing function to extract event summary information, subject information, temporal information, location information, and emotion information;
analyze the imaging information using an image analysis function to extract subject-matter information, scene information, and facial expression information;
generate an integrated feature representation of the past event based on the event summary information, the subject information, the temporal information, the location information, the emotion information, the subject-matter information, the scene information, and the facial expression information;
construct a prompt sentence comprising the integrated feature representation and input the prompt sentence to a generative neural network model to obtain generated content output from the generative neural network model;
generate, based on the generated content, a plurality of frame images using an image generation model, and assemble the frame images into a visual output sequence; and
transmit the visual output sequence to the terminal device via the communication interface.

2. The system according to claim 1, wherein the circuitry is configured to analyze the descriptive information by applying tokenization, named entity recognition, and sentiment classification to the descriptive information, and to extract the emotion information as an emotion label and an emotion intensity score.

3. The system according to claim 2, wherein the circuitry is configured to analyze the imaging information by applying an object detection model and a facial expression classifier to the imaging information, and to extract the facial expression information as a classified expression label associated with a detected face region.

4. The system according to claim 3, wherein the circuitry is configured to generate the integrated feature representation by concatenating the event summary information, the subject information, the temporal information, the location information, the emotion label, the emotion intensity score, the subject-matter information, the scene information, and the facial expression label into a structured text representation.

5. The system according to claim 4, wherein the circuitry is configured to construct the prompt sentence by encoding the integrated feature representation with generation instruction prefixes specifying at least a content structure, a narrative style, and an emotion-matching constraint for the generative neural network model.

6. The system according to claim 1, wherein the circuitry is configured to receive, from the terminal device via the communication interface, a modification instruction specifying a change to at least one of a length, a writing style, or a description target of the generated content, automatically generate an additional prompt sentence based on the generated content and the integrated feature representation, and re-input the additional prompt sentence to the generative neural network model to obtain a revised version of the generated content.

7. The system according to claim 6, wherein the circuitry is configured to generate the additional prompt sentence by appending the modification instruction and the current generated content as input context to the integrated feature representation, thereby enabling iterative revision of the generated content through programmatic prompt generation.

8. The system according to claim 1, wherein the circuitry is configured to generate the frame images by inputting, to the image generation model, a sequence of image generation prompts each corresponding to a segment of the generated content, the image generation prompts comprising at least a scene description, a subject description, and a style parameter derived from the integrated feature representation.

9. The system according to claim 8, wherein the circuitry is configured to assemble the frame images into the visual output sequence by arranging the frame images in a temporal order corresponding to the sequence of segments of the generated content, and to apply at least one of a transition effect or an audio synchronization parameter between successive frame images.

10. The system according to claim 1, wherein the circuitry is configured to estimate a current emotional state of the user based on text data or image data received from the terminal device, and to adjust a generation parameter of the generative neural network model based on the estimated current emotional state to bias the generated content toward a tone matching the current emotional state.

11. The system according to claim 10, wherein the circuitry is configured to classify the current emotional state into an emotional category using an emotion identification model, and to select a narrative style parameter from a plurality of narrative style parameters based on the classified emotional category, the narrative style parameter being incorporated into the prompt sentence.

12. The system according to claim 11, wherein the circuitry is configured to dynamically adjust the visual output sequence by regenerating frame images using an updated set of image generation prompts when the estimated current emotional state changes by more than a threshold between successive interactions.

13. The system according to claim 1, wherein the circuitry is configured to store the descriptive information, the imaging information, and the integrated feature representation in a storage device, and to retrieve stored integrated feature representations to generate combined content representing multiple past events when a combination instruction is received from the terminal device.

14. The system according to claim 13, wherein the circuitry is configured to generate the combined content by constructing a merged prompt sentence comprising integrated feature representations of the plurality of past events, and to input the merged prompt sentence to the generative neural network model to produce content integrating elements from each of the past events.

15. The system according to claim 1, wherein the circuitry is configured to operate in conjunction with an information processing terminal operated by the user, and to transmit the visual output sequence together with a user interface rendering instruction that causes the information processing terminal to display the visual output sequence and provide controls for requesting a modification instruction.

16. The system according to claim 1, wherein the circuitry is configured to generate a virtual environment representation based on the integrated feature representation and the visual output sequence by constructing a spatial layout model from the scene information and the location information, and to transmit the virtual environment representation to the terminal device for rendering as an interactive visual environment.

17. The system according to claim 16, wherein the circuitry is configured to update the virtual environment representation based on a current emotional state of the user estimated from input signals received from the terminal device, such that at least one of a lighting parameter, a spatial arrangement, or an environmental effect of the virtual environment representation is adjusted to correspond to the current emotional state.

18. A system comprising:
circuitry configured to:
receive, via a communication interface coupled to a packet-switched network, descriptive information and imaging information associated with a past event from a terminal device operated by a user;
apply tokenization, named entity recognition, and sentiment classification to the descriptive information to extract event summary information, temporal information, location information, and emotion information comprising an emotion label and an emotion intensity score;
apply an object detection model and a facial expression classifier to the imaging information to extract subject-matter information, scene information, and facial expression information;
generate an integrated feature representation by concatenating the extracted information into a structured text representation, construct a prompt sentence encoding the integrated feature representation with generation instruction prefixes, and input the prompt sentence to a transformer-based generative neural network model to obtain generated content;
generate a plurality of frame images by inputting image generation prompts derived from segments of the generated content to an image generation model, and assemble the frame images into a visual output sequence; and
transmit the visual output sequence to the terminal device via the communication interface.

19. The system according to claim 18, wherein the circuitry is configured to estimate a current emotional state of the user from text data or image data received from the terminal device, classify the emotional state into an emotional category, and select a narrative style parameter based on the classified emotional category to adjust generation parameters of the transformer-based generative neural network model.

20. A method comprising:
receiving, via a communication interface coupled to a packet-switched network, descriptive information and imaging information associated with a past event from a terminal device operated by a user;
analyzing the descriptive information using a natural language processing function to extract event summary information, subject information, temporal information, location information, and emotion information;
analyzing the imaging information using an image analysis function to extract subject-matter information, scene information, and facial expression information;
generating an integrated feature representation of the past event based on the event summary information, the subject information, the temporal information, the location information, the emotion information, the subject-matter information, the scene information, and the facial expression information;
constructing a prompt sentence comprising the integrated feature representation and inputting the prompt sentence to a generative neural network model to obtain generated content output from the generative neural network model;
generating, based on the generated content, a plurality of frame images using an image generation model, and assembling the frame images into a visual output sequence; and
transmitting the visual output sequence to the terminal device via the communication interface.
